(19) United States
(12) Patent Application Publication
(10) Pub. No.: US 2023/0299330 A1
(43) Pub. Date: Sep. 21, 2023

(54) GRAPHENE-FUNCTIONALIZED COMPOSITES FOR BATTERY ANODES, FORMING METHODS AND APPLICATIONS OF SAME

(71) Applicant: NORTHWESTERN UNIVERSITY, Evanston, IL (US)

(72) Inventors: Mark C. Hersam, Wilmette, IL (US); Jin-Myoung Lim, Coppell, TX (US)

(21) Appl. No.: 18/021,429

(22) PCT Filed: Aug. 6, 2021
(86) PCT No.: PCT/US2021/044873

§ 371 Date: Feb. 15, 2023

Related U.S. Application Data
(63) Continuation-in-part of application No. 17/369,058, filed on Jul. 7, 2021.
Application No. 17/369,058 is a division of application No. 15/906,776, filed on Feb. 27, 2018, now Pat. No. 11,088,392.
Application No. PCT/US2021/044873 is a continuation-in-part of application No. 15/906,776, filed on Feb. 27, 2018, now Pat. No. 11,088,392.
(60) Provisional application No. 63/067,948, filed on Aug. 20, 2020.
(60) Provisional application No. 62/464,167, filed on Feb. 27, 2017.
(60) Provisional application No. 62/464,167, filed on Feb. 27, 2017.

(51) Int. Cl. H01M 10/0525; H01M 4/505; H01M 4/04; H01M 4/1393; H01M 4/131; H01M 4/133; H01M 4/134; H01M 4/62; H01M 4/139; H01M 4/136

(52) U.S. Cl. CPC H01M 10/0525; H01M 4/505; H01M 4/0416; H01M 4/1393; H01M 4/131; H01M 4/133; H01M 4/134; H01M 4/625; H01M 4/139; H01M 4/136; H01M 2004/028

(57) ABSTRACT

A composite, an anode electrode for an electrochemical device including said composite, and a fabricating method of said composite. Said composite includes graphene and nanoparticles of an active material, wherein said nanoparticles are conformally coated and networked by said graphene.

### CROSS-REFERENCE TO RELATED PATENT APPLICATIONS

This application claims priority to and the benefit of U.S. Provisional Application No. 63/067,948, filed Aug. 20, 2020, which is incorporated herein in its entirety by reference.

This application is also a continuation-in-part application of U.S. application Ser. No. 17/369,058, filed Jul. 7, 2021, which is a divisional application of U.S. application Ser. No. 15/906,776, filed Feb. 27, 2018, now allowed, which itself claims priority to and the benefit of U.S. Provisional Application Ser. No. 62/464,167, filed Feb. 27, 2017, which are incorporated herein in their entireties by reference.

This application is also a continuation-in-part application of U.S. application Ser. No. 15/906,776, filed Feb. 27, 2018, now allowed, which itself claims priority to and the benefit of U.S. Provisional Application Ser. No. 62/464,167, filed Feb. 27, 2017, which are incorporated herein in their entireties by reference.

### STATEMENT AS TO RIGHTS UNDER FEDERALLY-SPONSORED RESEARCH

This invention was made with government support under DEAC02-06CH11357 awarded by the Department of Energy and 1727846 and 1720139 awarded by the National Science Foundation. The government has certain rights in the invention.

### FIELD OF THE INVENTION

The present invention relates generally to materials, and more particularly to high volumetric energy and power density Li₂TiSiO₅ battery anodes via graphene functionalization, forming methods and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Lithium-ion batteries (LIBs) have been the most prevalent technology in the rechargeable battery market for the past two decades, with widespread applications ranging from portable electronic devices to electric vehicles (EVs). To enable EVs of increased size and range in addition to larger-scale applications such as grid-level energy storage, LIB electrodes must accommodate increasingly high volumetric energy and power densities. Recent work has identified promising candidates for high-power cathode materials that also possess significant improvements in energy density. However, research on anode materials has not yet identified a clear and viable substitute for graphite, particularly for applications that require both high volumetric energy and power densities.

Therefore, a heretofore unaddressed need exists in the art to address the aforementioned deficiencies and inadequacies.

### SUMMARY OF THE INVENTION

One of the objectives of this invention is to disclose a highly-packed electrode design that takes advantage of ethyl cellulose as a stabilizing polymer to concurrently disperse active nanoparticles and pristine graphene nanosheets in slurries that can be blade-coated onto current collectors. Subsequent thermal processing pyrolyzes the ethyl cellulose, which compacts the electrodes, coats the nanoparticles with graphene, and results in a continuous conductive carbon network throughout the electrode that facilitates charge transport and high-rate performance. In addition, the conductive graphene coating mitigates solid-electrolyte interphase (SEI) formation, reduces interfacial resistance, and minimizes overpotentials without compromising Li-ion diffusion, resulting in high volumetric energy and power densities.

In one aspect, the invention relates to a composite comprising graphene; and nanoparticles of an anode active material for an electrochemical device, wherein said nanoparticles are conformally coated and networked by said graphene.

In one embodiment, individual said nanoparticles, rather than multi-particle particulates, are conformally coated with said graphene.

In one embodiment, each of said nanoparticles is uniformly and conformally coated with said graphene.

In one embodiment, each of said nanoparticles is coated with amorphous carbon with sp²-carbon content along with said graphene.

In one embodiment, a weight ratio of said graphene to said nanoparticles of the anode active material is in a range from about 1:1000 to about 1:10.

In one embodiment, said graphene comprises solution-exfoliated graphene.

In one embodiment, the composite further comprises amorphous carbon with sp²-carbon content.

In one embodiment, the amorphous carbon is an annealation product of ethyl cellulose.

In one embodiment, the composite is formed by annealing a mixture of said nanoparticles, said graphene, and ethyl cellulose at a temperature for a period of time to decompose the ethyl cellulose, thereby resulting in said composite having said annealation product of the ethyl cellulose.

In one embodiment, the atomic structure of said composite is well-maintained during or/and after lithiation.

In one embodiment, said anode active material comprises Li₂TiSiO₅(LTSO), lithium titanium oxides, niobium oxides, titanium niobium oxides, or a combination thereof.

In one embodiment, the d-spacing along the [010] orientation of said composite is 0.648 nm.

In another aspect, the invention relates to an anode electrode for an electrochemical device, comprising a composite comprising graphene, and nanoparticles of an active material, wherein said nanoparticles are conformally coated and networked by said graphene.

In one embodiment, individual said nanoparticles, rather than multi-particle particulates, are conformally coated with said graphene.

In one embodiment, each of said nanoparticles is uniformly and conformally coated with said graphene.

In one embodiment, each of said nanoparticles is coated with amorphous carbon with sp²-carbon content along with said graphene.

In one embodiment, a weight ratio of said graphene to said nanoparticles of the active material is in a range from about 1:1000 to about 1:10.

In one embodiment, said graphene comprises solution-exfoliated graphene.

In one embodiment, said composite further comprises amorphous carbon with sp²-carbon content.

In one embodiment, the amorphous carbon is an annealation product of ethyl cellulose.

In one embodiment, said composite is formed by annealing a mixture of said nanoparticles, said graphene, and ethyl cellulose at a temperature for a period of time to decompose the ethyl cellulose, thereby resulting in said composite having said annealation product of the ethyl cellulose.

In one embodiment, the atomic structure of said composite is well maintained during or/and after lithiation.

In one embodiment, said active material comprises LTSO.

In one embodiment, the d-spacing along the [010] orientation of said composite is 0.648 nm.

In one embodiment, the atomic structure of the LTSO matrix and the graphene coating in the anode electrode remains intact following 300 cycles.

In one embodiment, in operation, said composite reversibly recovers a portion of the capacity lost in the first activation cycle.

In one embodiment, said anode electrode has suppressed surface phase transformation and reduced SEI formation during electrochemical cycling.

In one embodiment, said electrode has an electrode packing density higher than 1.0 g cm⁻³, and an operating voltage lower than 1.5 V.

In one embodiment, the electrode packing density is equal to or greater than 50% of the theoretical electrode packing density.

In one embodiment, said electrode has a volumetric energy density greater than that of an electrode formed of a non-alloying anode material.

In one embodiment, the volumetric energy density extends over a wide specific current range between 10¹ and 10⁴ mA g⁻¹.

In yet another aspect, the invention relates to a method for forming a composite, comprising agitating a mixture of nanoparticles of an anode active material, graphene, and ethyl cellulose in a solvent to disperse said nanoparticles and said graphene with the ethyl cellulose so as to prevent aggregation of said nanoparticles; and annealing the agitated mixture at a temperature for a period of time to decompose the ethyl cellulose, thereby resulting in said composite, wherein said nanoparticles are conformally coated and networked by said graphene.

In one embodiment, individual said nanoparticles, rather than multi-particle particulates, are conformally coated with said graphene.

In one embodiment, each of said nanoparticles is uniformly and conformally coated with said graphene.

In one embodiment, each of said nanoparticles is coated with amorphous carbon with sp²-carbon content along with said graphene.

In one embodiment, a weight ratio of said graphene to said nanoparticles of the anode active material is in a range from about 1:1000 to about 1:10.

In one embodiment, said graphene comprises solution-exfoliated graphene.

In one embodiment, said composite further comprises amorphous carbon with sp²-carbon content.

In one embodiment, the amorphous carbon is an annealation product of ethyl cellulose.

In one embodiment, the atomic structure of said composite is well-maintained during or/and after lithiation.

Embodiments of the invention presents graphene-coated LTSO (G-LTSO) as a high volumetric energy and power density anode for lithium-ion batteries. As disclosed below, G-LTSO forms a highly-packed electrode structure with electronically and ionically conductive networks to deliver superior electrochemical performance. The graphene coating yields minimal structural changes and reduced amorphization compared to pristine LTSO, resulting in high cycling stability. Furthermore, G-LTSO exhibits not only high charge and discharge capacities but also low overpotentials at high rates with minimal voltage fading due to low charge-transfer resistances and reduced formation of solid-electrolyte interphase. The combination of highly-compacted electrode morphology, stable high-rate electrochemistry, and low operating potential enables G-LTSO to achieve exceptional volumetric energy and power densities that overcome incumbent challenges for lithium-ion batteries.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIGS. 1A-1H show structural analysis of LTSO and G-LTSO, according to embodiments of the invention. FIG. 1A: XRD patterns of G-LTSO (red), LTSO (blue), and the reference (JCPDS #04-010-4344; black). FIG. 1B: Atomic model of the tetragonal LTSO structure with the P4/nmm space group: Ti (cyan), O (red), Si (blue), Li (green). FIGS. 1C-1D: (FIG. 1C) TEM and (FIG. 1D) HRTEM images of LTSO. The inset in (FIG. 1D) shows the pristine structure of [001]-oriented single-crystal LTSO. FIGS. 1E-1F: (FIG. 1E) HAADF-STEM image of an LTSO nanoparticle and (FIG. 1F) EELS profiles of Ti, Si, and O obtained along the red line in (FIG. 1E). The inset in (FIG. 1E) shows the SAED pattern of [011]-oriented single-crystal LTSO. FIGS. 1G-1H: (FIG. 1G) TEM and (FIG. 1H) HRTEM images of G-LTSO, with the red arrows indicating graphene nanoflakes.

FIGS. 2A-2H show transmission electron microscopy analysis of Lithiated G-LTSO, according to embodiments of the invention. FIGS. 2A-2B: (FIG. 2A) Time-lapse TEM images of G-LTSO during the first lithiation step and (FIG. 2B) the area changes during lithiation. FIGS. 2C-2F: SAED patterns of G-LTSO (FIG. 2C) initially and (FIG. 2D) after lithiation, and the corresponding HRTEM images obtained from G-LTSO (E) before and (F) after lithiation. FIGS. 2G-2H: (FIG. 2G) STEM and (FIG. 2H) enlarged HRTEM images of a G-LTSO electrode sample prepared by focused ion beam (FBI) milling after 300 cycles at 3C.

FIGS. 3A-3F show electrochemical measurements of LTSO and G-LTSO, according to embodiments of the invention. FIG. 3A: Rate capability at various C-rates from C/10 to 30C after an initial activation cycle at C/20. FIGS. 3B-3C: The corresponding dQ/dV profiles of (FIG. 3B) LTSO and (FIG. 3C) G-LTSO at 0.1C, 0.5C, 1C, 5C, and 10C. FIG. 3D: Cycle performance and coulombic efficiency at 1C after an initial activation cycle at C/20. FIGS. 3E-3F: The corresponding dQ/dV profiles of (FIG. 3E) LTSO and (FIG. 3F) G-LTSO at the 5^{th}, 10^{th}, 30^{th}, and 50^{th} cycles.

FIGS. 4A-4I show electrochemical impedance spectroscopy and X-ray photoelectron spectroscopy, according to embodiments of the invention. FIGS. 4A-4C: Electrochemical impedance spectra of LTSO (black) and G-LTSO (red) at (FIG. 4A) open-circuit voltage (OCV) condition, (FIG. 4B) after 1^{st} charge, and (FIG. 4C) after 20^{th} charge. The plotted circles are the measured spectra, and the lines are equivalent circuit model fits. FIGS. 4D-4F: (FIG. 4D)C1s, (FIG. 4E) F1s, and (FIG. 4F) P2p X-ray photoelectron spectra of LTSO (gray) and G-LTSO (purple) at the open-circuit voltage (OCV) condition. FIGS. 4G-4I: (FIG. 4G) C1s, (FIG. 4H) F Is, and (FIG. 4I) P2p X-ray photoelectron spectra of LTSO (gray) and G-LTSO (purple) after 1,000 charge/discharge cycles.

FIGS. 5A-5B show electrode packing percentage and volumetric energy density, according to embodiments of the invention. FIG. 5A: Electrode packing percentage of G-LTSO and other reported anode materials. FIG. 5B: Volumetric energy density as a function of specific current versus a 4 V cathode for G-LTSO and other reported non-alloying anode materials (Nb₁₆W₅O₅₅, Nb₂O₅/G, T-Nb₂O₅, LTO/C, T/LTO, and graphite).

FIGS. 6A-6B show SEM images of Li₂TiSiO₅(LTSO) and graphene-functionalized LTSO (G-LTSO), respectively.

FIGS. 7A-7D show that the pristine LTSO particles possess a uniform composition.

FIGS. 7A and 7C: HAADF STEM images of pristine LTSO particles. FIGS. 7B and 7D: EDS mapping.

FIGS. 8A-8G show structural analysis of G-LTSO, according to embodiments of the invention. FIG. 8A: TEM images of G-LTSO particles initially (top) and after lithiation (bottom). FIG. 8B: SAED patterns obtained from the regions highlighted by the blue circles in (FIG. 8A). FIGS. 8C-8D: HRTEM images obtained from the red and the yellow square regions in (FIG. 8A). The upper images and the lower images are before and after lithiation, respectively. The LTSO particle in (FIG. 8C) is uniformly coated with graphene, but the LTSO particle in (FIG. 8D) is lacking graphene. FIG. 8E: FFT pattern from the upper HRTEM image in (FIG. 8D). FIG. 8F: HRTEM image after lithiation from the red square region in (FIG. 8D). While G-LTSO retains its original structure, the LTSO particle without graphene layers shows a disordered structure under the same electrochemical lithiation conditions. FIG. 8G: Distance of (110) planes before and after lithiation as calculated from the FFT patterns of (FIG. 8E) and the inset of (FIG. 8G), which is derived from image (FIG. 8F).

FIG. 9 shows radial profiles converted from SAED patterns (A: pristine graphene, B: lithiated graphene, C: pristine G-LTSO, and D: lithiated G-LTSO), according to embodiments of the invention.

FIG. 10 shows EDS elemental mapping images of FIG. 2G for Ti, Si, O, and C, according to embodiments of the invention.

FIGS. 11A-11B show electrochemical performance of LTSO and G-LTSO coin-cell electrodes, according to embodiments of the invention. FIG. 11A: Charge-discharge profiles of LTSO and G-LTSO at C/20 (15 mA g⁻¹) between 0.1 and 3.0 V vs. Li/Li⁺. FIG. 11B: The corresponding dQ/dV profiles.

FIGS. 12A-12B show charge-discharge profiles of LTSO and G-LTSO at different C-rates, respectively.

FIGS. 13A-13B show equivalent circuit models (ECMs) used for fitting the electrochemical impedance spectra (FIG. 13A) at the open-circuit voltage condition and (FIG. 13B) after electrochemical cycling.

FIG. 14 shows thermogravimetric analysis in air of exfoliated graphene nanoflakes.

FIG. 15A shows atomic force microscopy image of the exfoliated graphene nanoflakes. FIGS. 15B and 15C show respectively lateral width and thickness histograms extracted from FIG. 15A.

FIG. 16 show an SEM image of the exfoliated graphene nanoflakes.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

Li-ion batteries (LIBs) are the dominant energy storage technology for diverse applications ranging from portable electronics to electric vehicles. As electric vehicles increase in size and range, volumetric energy density and high-rate capability have emerged as critical Li-ion battery performance metrics. While graphite has been the clear leader for Li-ion battery anodes for the past two decades, graphite anodes are vulnerable to localized overpotentials during fast charging at low operating potentials (<0.1 V vs. Li/Li⁺), which results in a high-impedance solid-electrolyte interphase (SEI) and plated Li metal. The resulting Li dendrite formation causes internal short-circuits, which deteriorates electrochemical performance and leads to major safety issues. Although alloying anode materials such as Si promise remarkably large specific capacity (e.g., Si has a theoretical capacity of 4200 mAh g⁻¹ upon full lithiation to Li₂₂Si₅), severe volume expansion, material pulverization, and SEI formation hamper the use of alloying anode materials in practical applications. In contrast, spinel lithium titanate (Li₄Ti₅O₁₂) is an anode material with improved safety and stability as a result of its ‘zero-strain’ characteristic, but its high operating potential (>1.5 V vs. Li/Li⁺) and low theoretical capacity (175 mAh g⁻¹) substantially compromise energy density. Recently, niobium oxide compounds have also been spotlighted as high-rate anode materials with large specific capacities of about 250 mAh g⁻¹ and about 150 mAh g⁻¹ at 0.2C (34.3 mA g⁻¹) and 10C (1.7 A g⁻¹), respectively. However, similar to lithium titanate, niobium oxide compounds operate at high voltages (>1.0 V vs. Li/Li⁺), and consequently also possess modest energy densities. Although each of these anode materials has unique strengths that suggest viability in niche applications, a need still exists for a low voltage anode material with minimal overpotential, stable cycling, and concurrently high volumetric energy and power density.

Li₂TiSiO₅(LTSO) has emerged as a promising LIB anode material with a specific charge capacity of 350 mAh g⁻¹ at 0.02 A g⁻¹ and low operating potential of 0.28 V vs. Li/Li⁺. Nanoscale LTSO also has high-rate capability, exhibiting a specific capacity of 175 mAh g⁻¹ at 1 A g⁻¹, in addition to minimal voltage fading when formed into composite electrodes with expanded graphite. Moreover, LTSO nanoparticles have shown potential for Li-ion capacitor applications due to stable capacity-voltage curves with low polarization upon cycling. However, nanoparticle-based electrodes formed via standard slurry coating methods have historically suffered from poor packing densities, which has implied relatively low volumetric energy densities. While high pressure treatments can force nanoparticles into higher packing densities, the resulting electrodes suffer from low porosity that blocks pathways for Li-ion diffusion, resulting in compromised high-rate performance.

One of the objectives of this invention is to disclose a highly-packed electrode design to preserve all of the desirable attributes of nanoscale LTSO, while also achieving high electrode packing and correspondingly high volumetric energy and power densities.

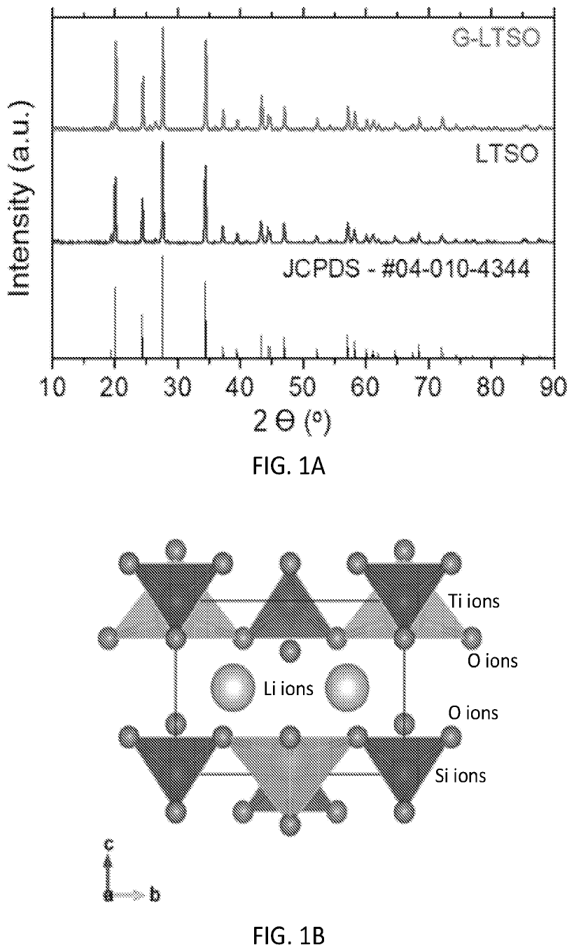

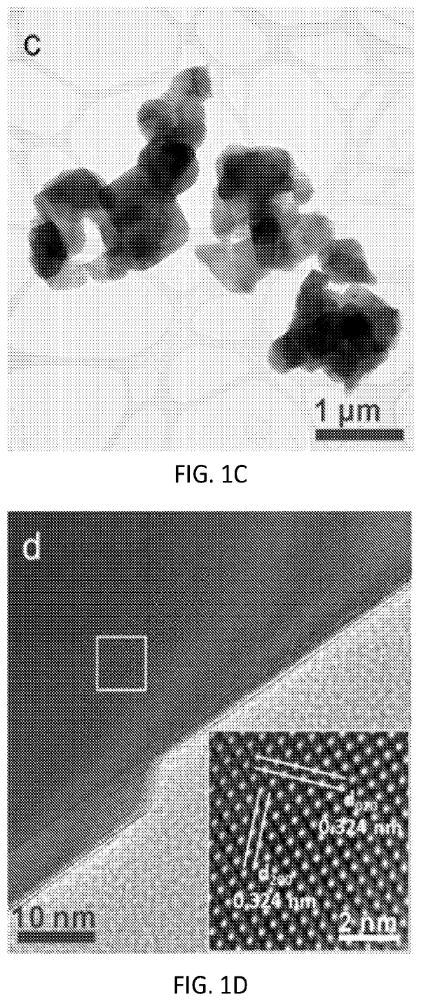

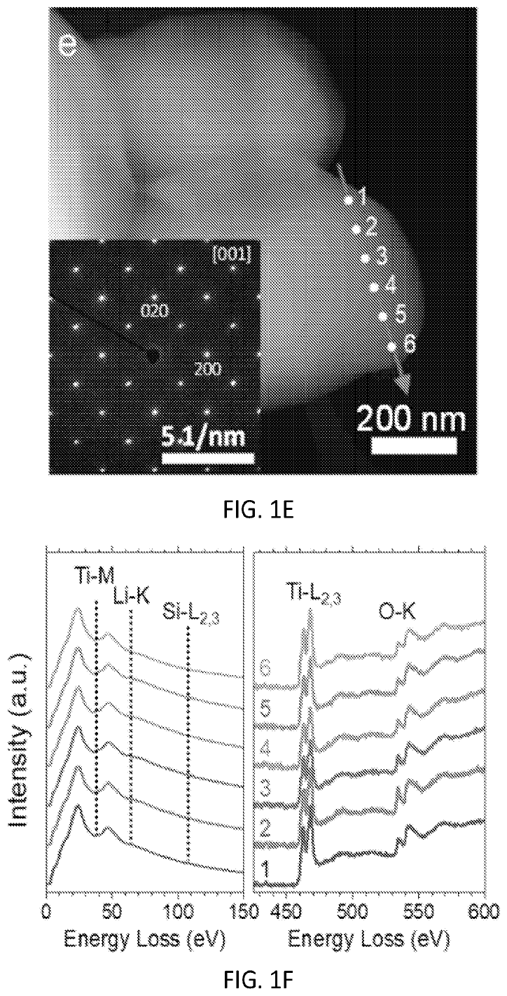

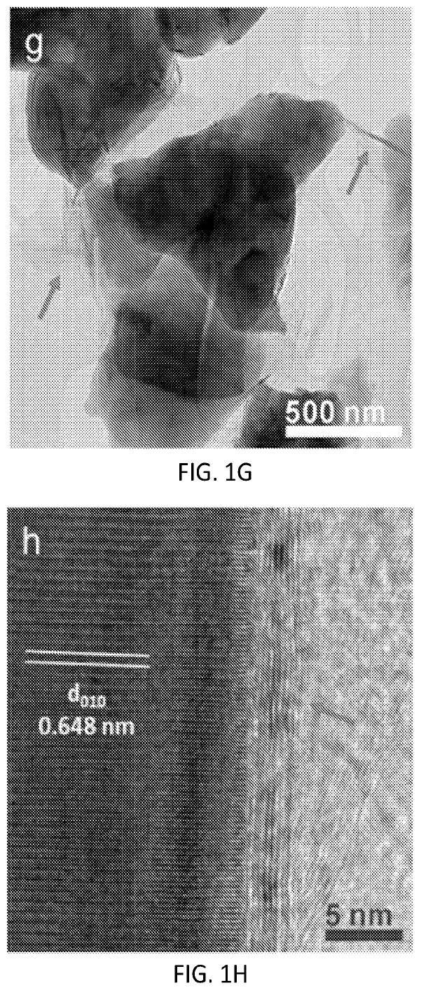

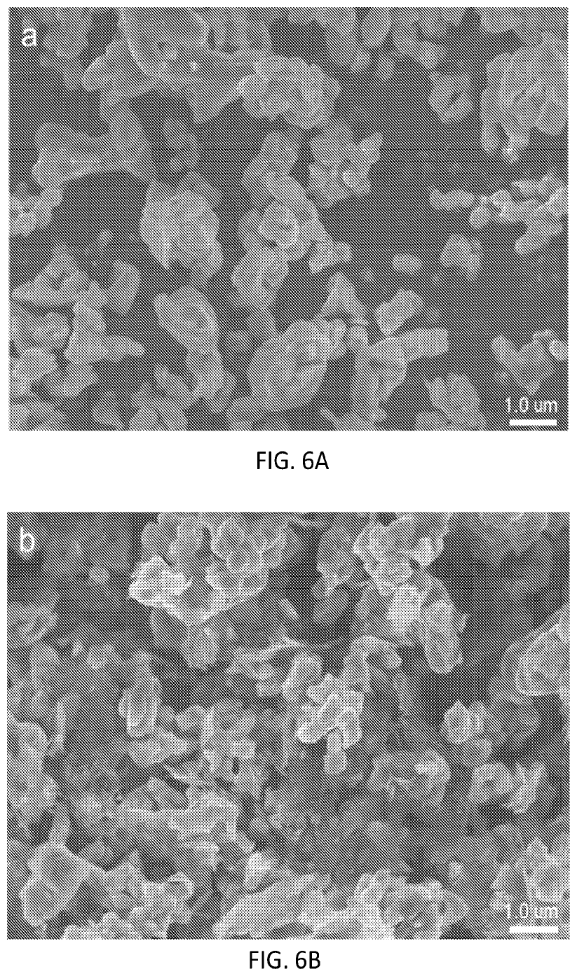

In one aspect, the invention relates to a composite comprising graphene; and nanoparticles of an anode active material for an electrochemical device, wherein said nanoparticles are conformally coated and networked by said graphene, as shown in FIG. 1G, indicated by the arrows, and FIG. 6B.

In another aspect, the invention relates to an anode electrode for an electrochemical device such an LIB, comprising a composite comprising graphene, and nanoparticles of an active material, wherein said nanoparticles are conformally coated and networked by said graphene.

In yet another aspect, the invention relates to a method for forming a composite comprising agitating a mixture of nanoparticles of an anode active material, graphene, and ethyl cellulose in a solvent to disperse said nanoparticles and said graphene with the ethyl cellulose so as to prevent aggregation of said nanoparticles; and annealing the agitated mixture at a temperature for a period of time to decompose the ethyl cellulose, thereby resulting in said composite, wherein said nanoparticles are conformally coated and networked by said graphene. In some embodiments, the temperature is in a range of about 150-350° C., and the period of time is in a range of about 0.01-24 h in air or an oxidizing atmosphere.

In some embodiments, individual said nanoparticles, rather than multi-particle particulates, are conformally coated with said graphene.

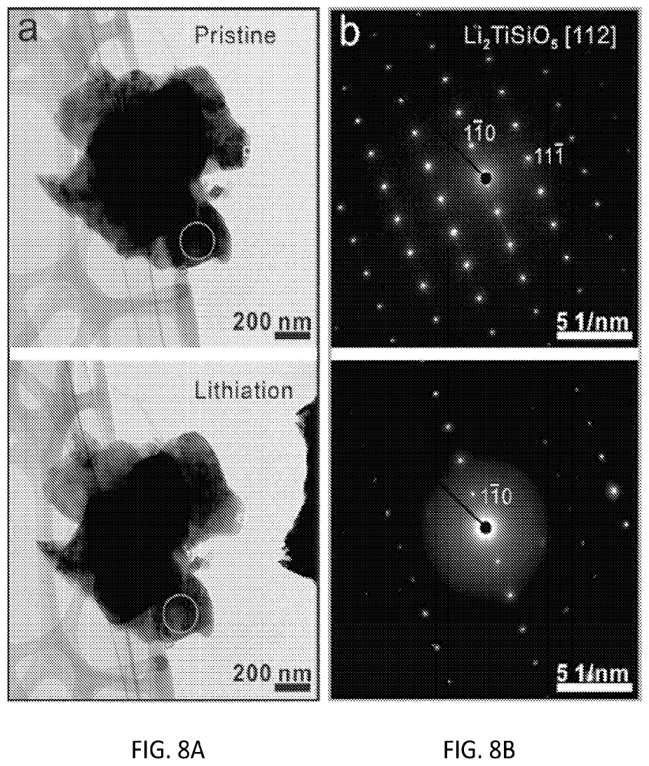

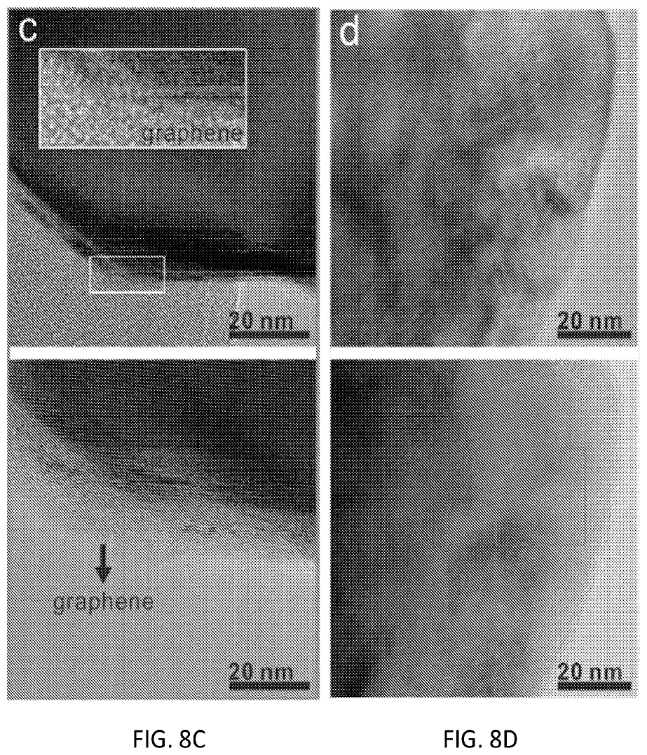

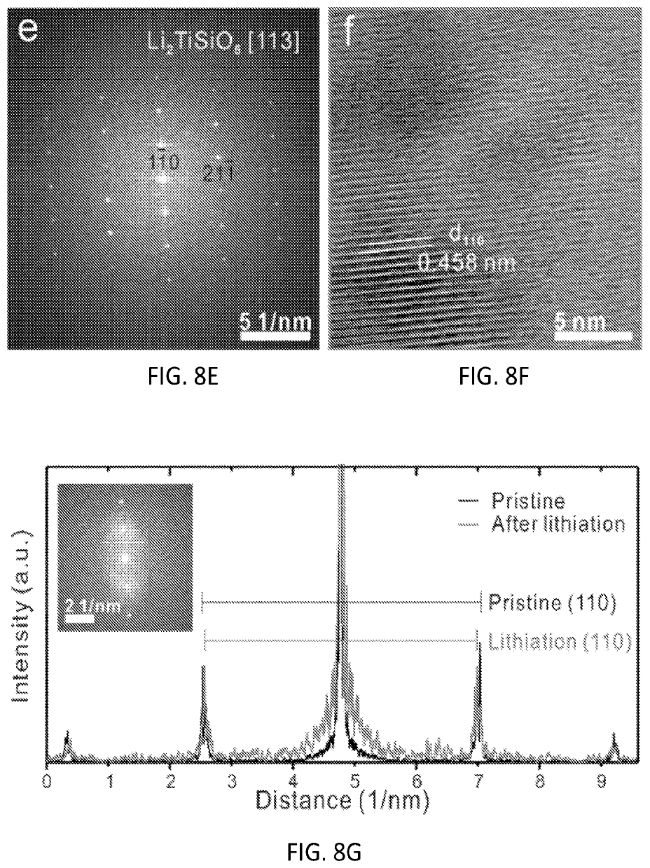

In some embodiments, each of said nanoparticles is uniformly and conformally coated with said graphene. In one embodiment shown in FIG. 8C, an LTSO particle is uniformly coated with said graphene.

In some embodiments, each of said nanoparticles is functionalized with said graphene. The functionalization here represents a bonding of graphene with sp² amorphous carbon on the anode surface so that the anode material can have a functionalized surface with high electrical conductivity.

In some embodiments, a weight ratio of said graphene to said nanoparticles of the active material is in a range from about 1:1000 to about 1:10.

In some embodiments, said graphene comprises solution-exfoliated graphene.

In some embodiments, said graphene is not graphene oxide and is not reduced graphene oxide.

In some embodiments, said composite further comprises amorphous carbon with sp²-carbon content.

In some embodiments, the amorphous carbon is an annealation product of ethyl cellulose.

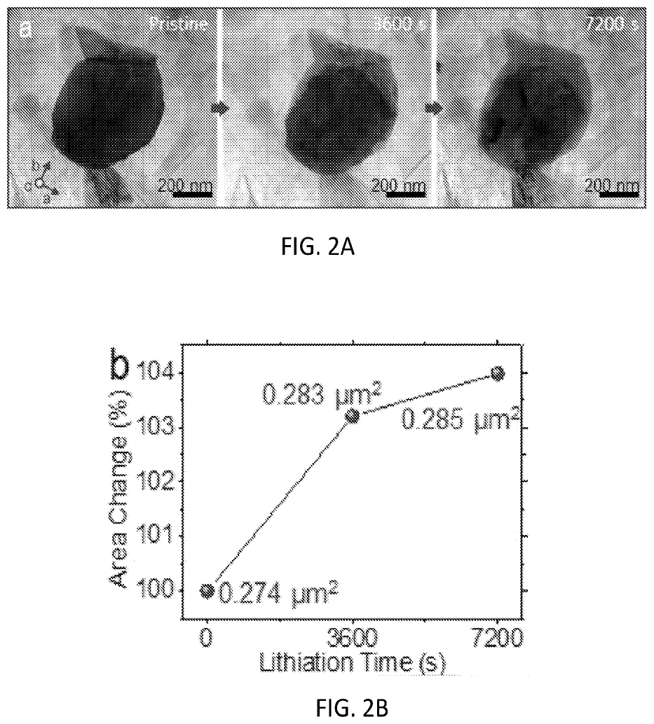

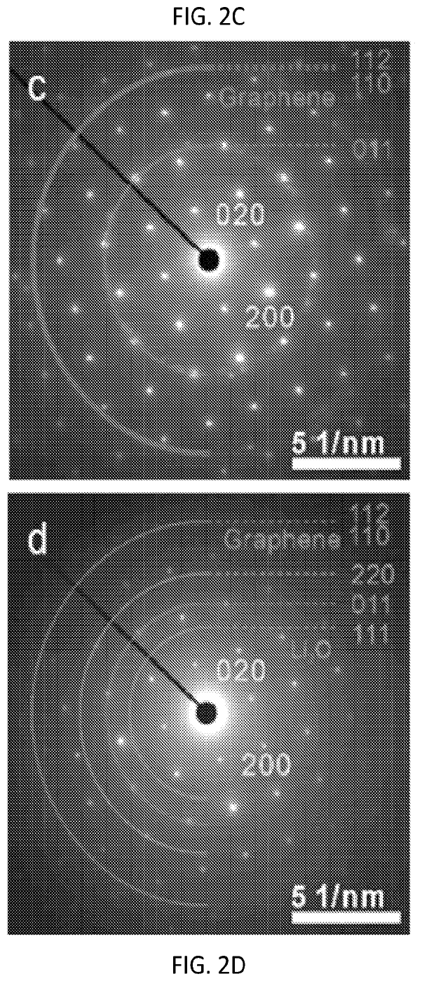

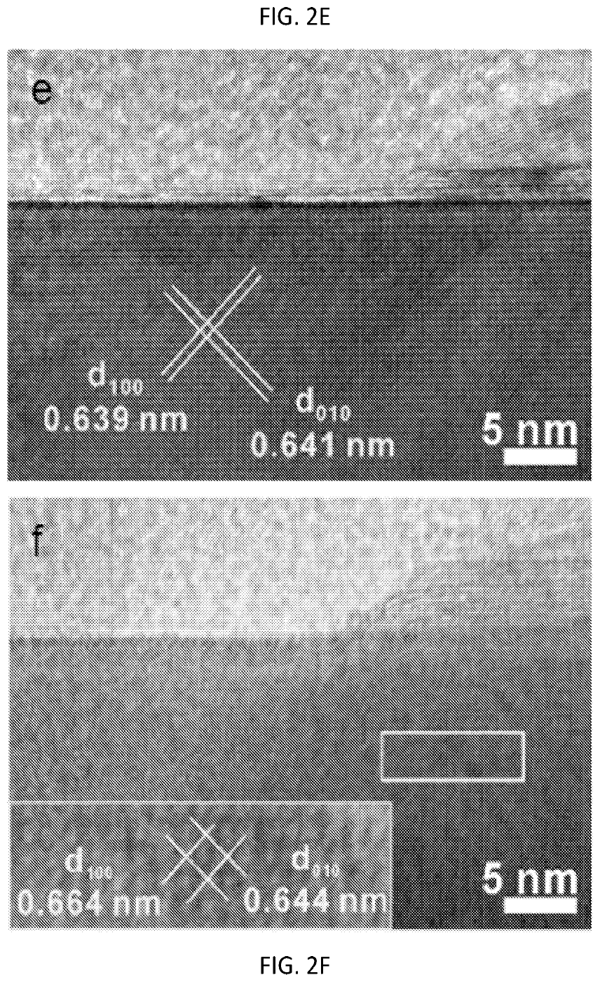

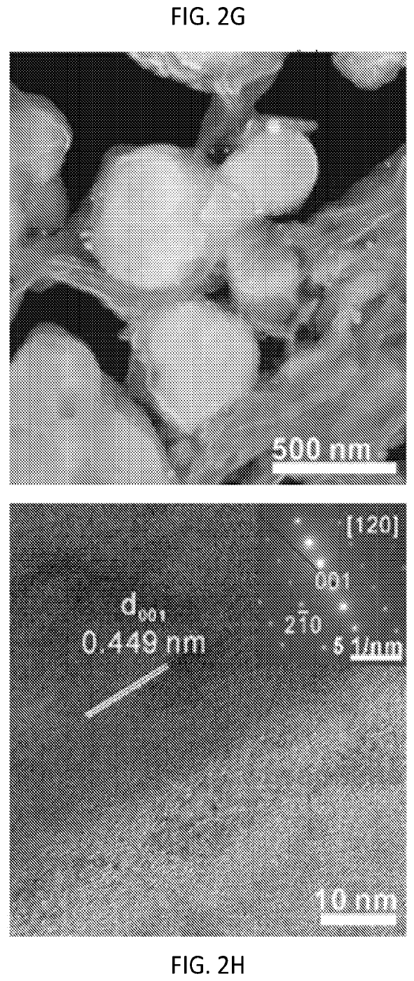

In some embodiments, the atomic structure of said composite is well-maintained during or/and after lithiation, as shown in FIGS. 2A, 2C-2F, 8A-8G and 9. The term “well-maintained” used herein the disclosure refers to the atomic structure is maintained very well during and/or after lithiation, for example, at least 90% of the atomic structure is intact during or/and after lithiation. In some embodiments, more than 99% of the atomic structure is intact during and/or after lithiation.

In some embodiments, said anode active material comprises LTSO, lithium titanium oxides, niobium oxides, titanium niobium oxides, or a combination thereof.

In some embodiments, the d-spacing along the [010] orientation of said composite is 0.648 nm, as shown in FIG. 1H.

In some embodiments, the atomic structure of the LTSO matrix and the graphene coating in the anode electrode remains intact following 300 cycles, as shown in FIG. 2G.

In some embodiments, in operation, said composite reversibly recovers a portion of the capacity lost in the first activation cycle, which may result in a Coulombic efficiency slightly higher than 100%.

In some embodiments, said anode electrode has suppressed surface phase transformation and reduced SEI formation during electrochemical cycling.

In some embodiments, said electrode has an electrode packing density higher than 1.0 g cm⁻³, and an operating voltage lower than 1.5 V.

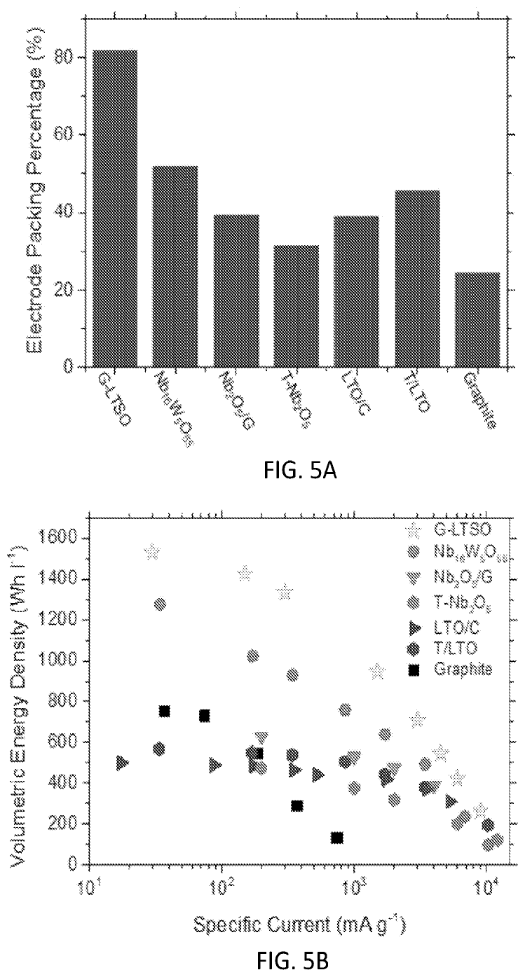

In some embodiments, the electrode packing density is equal to or greater than 50% of the theoretical electrode packing density, as shown in FIG. 5A and Table 2.

In some embodiments, said electrode has a volumetric energy density greater than that of an electrode formed of a non-alloying anode material.

In some embodiments, the volumetric energy density extends over a wide specific current range between 10¹ and 10⁴ mA g⁻¹, as shown in FIG. 5B and Table 3.

According to the invention, graphene-coated/functionalized LTSO (G-LTSO) forms a highly-packed electrode structure with electronically and ionically conductive networks to deliver superior electrochemical performance. The graphene coating yields minimal structural changes and reduced amorphization compared to pristine LTSO, resulting in high cycling stability. Furthermore, G-LTSO exhibits not only high charge and discharge capacities but also low overpotentials at high rates with minimal voltage fading due to low charge-transfer resistances and reduced formation of solid-electrolyte interphase. The combination of highly-compacted electrode morphology, stable high-rate electrochemistry, and low operating potential enables G-LTSO to achieve exceptional volumetric energy and power densities that overcome incumbent challenges for lithium-ion batteries. With these advantages, G-LTSO shows significant potential as a next-generation LIB anode for high volumetric energy and power density applications. In addition, G-LTSO can also have potential applications in Li-sulfur batteries, anode materials, conductive coatings, protective coatings, and so on.

Among other things, the invention provides at least the advantages over the existing art. Among existing anodes, graphite anodes forms a solid-electrolyte interphase (SEI) and Li dendrites during battery operation, especially at high rates, resulting in high impedance and safety concerns; alloying anodes such as silicon have severe volume expansion, structural changes, and SEI formation, resulting in high impedance, poor cycle life, and safety concerns; and titanate-based anodes such as Li₄Ti₅O₁₂ have intrinsically high operating potentials and low specific capacities, resulting in relatively low specific and volumetric energy densities. LTSO has intrinsically large capacity and low operating potential, resulting in high specific energy and minimal formation of Li dendrites. However, the intrinsically low electrical conductivity of LTSO has historically limited its high rate capability. In addition, pre-existing LTSO electrodes have poor packing density, which implies a low volumetric energy density.

As disclosed in the disclosure, a scalable graphene coating on LTSO overcomes the aforementioned issues, resulting in high electrical and ionic conductivity, low impedance, high rate capability, and high volumetric energy and power density. The graphene coating of LTSO also mitigates SEI formation and suppresses structural changes and volume expansion, resulting in a prolonged cycle life. The interplay of graphene and amorphous carbon composite in G-LTSO leads to a highly compacted electrode, resulting in a high packing density and thus high volumetric energy and power density. Overall, G-LTSO delivers superior volumetric and gravimetric energy density, high power density, high rate capability, prolonged cycle-life, minimal structural changes, and suppressed surface side reactions in Li-ion batteries.

These and other aspects of the present invention are further described below. Without intent to limit the scope of the invention, exemplary instruments, apparatus, methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### High Volumetric Energy and Power Density Li₂Tisio₅ Battery Anodes Via Graphene Functionalization

The realization of lithium-ion battery anodes with high volumetric energy densities but without Li plating at high rates remains a key challenge for emerging technologies including electric vehicles and grid-level energy storage. Although anode materials with high operating voltages such as lithium titanate have been substantially studied to avoid Li plating at high rates, this approach compromises energy density due to the reduced voltage window.

In this exemplary example, a highly-packed electrode design is disclosed, which achieves high volumetric energy and power density while maintaining the other advantages of nanoscale LTSO. This approach takes advantage of ethyl cellulose as a stabilizing polymer to concurrently disperse LTSO nanoparticles and pristine graphene nanosheets in slurries that can be blade-coated onto current collectors. Subsequent thermal processing pyrolyzes the ethyl cellulose, which compacts the electrodes, coats the LTSO with graphene (G-LTSO), and results in a continuous conductive carbon network throughout the electrode that facilitates charge transport and high-rate performance. In addition, the conductive graphene coating mitigates SEI formation, reduces interfacial resistance, and minimizes overpotentials without compromising Li-ion diffusion, resulting in high volumetric energy and power densities. To gain atomic-scale insight into the graphene coating and the resulting electrochemical behavior of G-LTSO, in situ transmission electron microscopy (TEM) reveals that lithitiation yields minimal structural changes and reduced amorphization for G-LTSO compared to pristine LTSO. The scalable nature of this solution-based electrode processing methodology suggests that G-LTSO can be seamlessly employed as a next-generation LIB anode for high volumetric energy and power density applications.

### Experimental Procedures

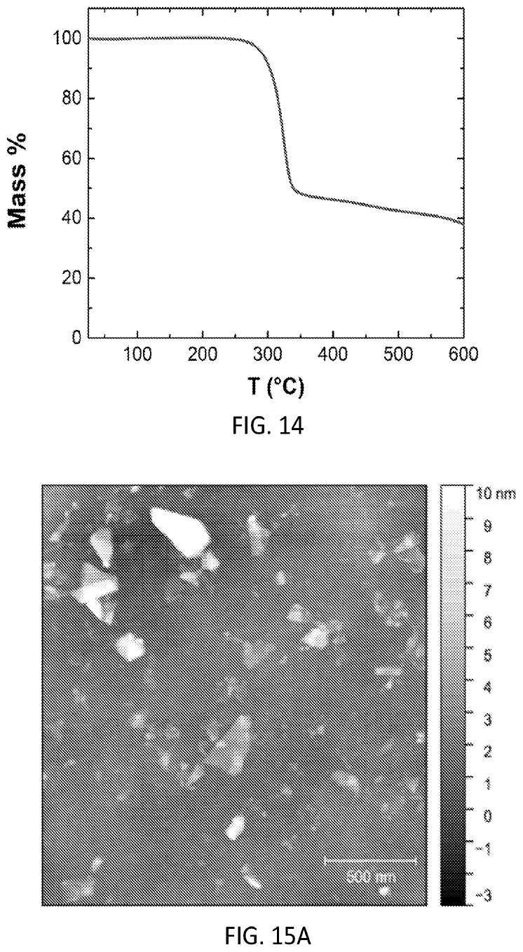

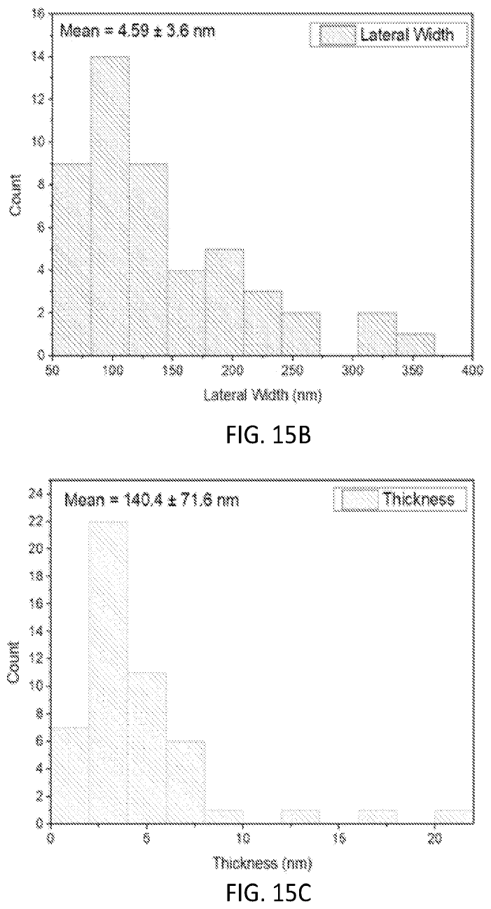

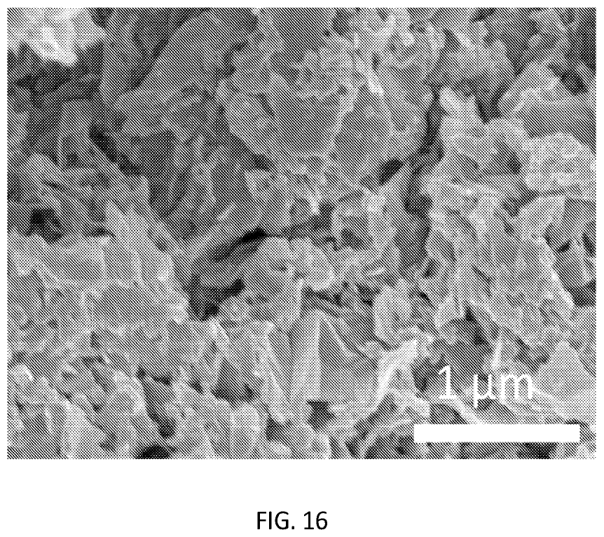

Material Preparation: Li₂TiSiO₅ (LTSO) was synthesized as following a previously published procedure. Briefly, stoichiometric amounts of lithium hydroxide monohydrate (Sigma-Aldrich) dissolved in deionized water were mixed with stoichiometric amounts of titanium (IV) butoxide (Sigma-Aldrich) and tetraethyl orthosilicate (Sigma-Aldrich) dissolved in ethanol. After stirring for 3 h at room temperature, the mixed solution was dried at 80° C. on a magnetic hotplate with continuous stirring. Subsequently, the dried powder was sintered at 870° C. for 8 h under an argon atmosphere to obtain LTSO. Ethyl cellulose stabilized graphene nanoflakes (Gr/EC) were prepared by following previously established methods with the following modifications. In particular, a 10 mg/mL solution of ethyl cellulose (4 cP, Sigma-Aldrich) in 200-proof ethanol was mixed with graphite (+150 mesh, Sigma-Aldrich) with a ratio of graphite powder to ethyl cellulose solution of 100 g: 1 L. Next, this mixture was shear mixed at 10,230 rpm for 2.5 h in a Silverson L5M-A high shear mixer and centrifuged at 6,500 rpm for 0.5 h using a Beckman Coulter J26 XPI centrifuge with a JLA 8.100 rotor. The supernatant was flocculated by mixing with 0.04 g/mL NaCl aqueous solution in a 9:16 wt. ratio (NaCl(aq):supernatant), and then again centrifuged at 7,000 rpm for 6 min. The obtained solid was washed in deionized water, filtered, and dried to collect the Gr/EC powder with about 45 wt. % graphene (FIG. 14). The average size of the resulting graphene nanoflakes was 140 nm in lateral width and 4.6 nm in thickness, and the morphology of the Gr/EC powder exhibits thin nanoflakes as shown in FIGS. 15A-15C and 16, respectively. For graphene functionalization, Gr/EC dispersion was prepared by dissolving 0.111 g of Gr/EC powder in 15 mL of ethyl lactate/ethanol in a 1:2 volume ratio. The prepared dispersion was sonicated using a Fisher Scientific Model 500 Sonic Dismembrator with 0.125-inch tip at 30 W for 1 h. Subsequently, 0.95 g of as-synthesized LTSO was mixed in the sonicated dispersion and stirred for 1 h. The mixed dispersion was then bath sonicated for 1 h to ensure homogeneous dispersion of LTSO and graphene. This dispersion was cast onto an Al foil and dried in a convection oven at 90° C., after which further calcination was performed at 250° C. for 1 h in air. The final G-LTSO product was prepared by scraping the dried powder from the Al foil.

Structural Characterization: The crystal structures of the as-prepared powders were characterized using X-ray diffraction (XRD) measured with a Scintag XDS2000 XRD system equipped with Cu-Kα radiation (λ=1.5406 Å) with a 2θ range of 10-90°. Particle morphologies and sizes were examined by scanning electron microscopy (SEM; Hitachi SU8030). Further structural characterization was performed using transmission electron microscopy (TEM; JEOL ARM 300CF and JEOL ARM 200CF). The TEM samples were prepared by a direct application of the pristine powder on a lacey carbon supported TEM grid. For in situ TEM characterization, G-LTSO nanoparticles were mounted on TEM grids and connected to a Nanofactory TEM-STM holder, resulting in a half-cell inside the TEM. Li metal with a Li₂O solid electrolyte was connected to a piezo-driven metal probe in an Ar-filled glovebox and assembled with a TEM holder. During the in situ electrochemical reaction inside the TEM, a constant potential was maintained between the sample and Li metal. The in situ lithiation of G-LTSO was performed on a JEOL ARM 300CF TEM operated at 300 kV, and TEM images were recorded using a Gatan OneView-IS camera with 4k×4k resolution. Focused ion beam (FIB) milling was performed using a FEI Helios NanoLab DualBeam system, and X-ray photoelectron spectroscopy (XPS) measurements were conducted using a Thermo Scientific ESCALAB 250Xi.

Electrochemical Measurements: Battery electrodes were prepared by fabricating an anode slurry with the active material, Super-P as a conducting agent, and polyvinylidene fluoride (PVDF) as a binder dispersed in N-methyl-2-pyrrolidone (NMP) with weight ratios of 60:30:10 for LTSO and 80:10:10 for G-LTSO. The well-mixed slurries were coated on Cu foils and dried at 80° C. for 3 h, followed by further drying under vacuum overnight. CR2032 coin-type half-cells were assembled in an Ar-filled glove box by using glass fiber (Whatman) as a separator and Li metal as a counter electrode. 1.0 M LiPF₆ in ethylene carbonate/dimethyl carbonate with 50/50 volume ratio was utilized as the electrolyte (Sigma-Aldrich). The loading levels of LTSO and G-LTSO were about 1.3 and about 1.5 mg cm⁻², and the electrode densities of each electrode were about 1.1 and about 2.1 g cm⁻³, respectively. Galvanostatic charge and discharge tests were performed by using an Arbin battery tester (LBT-20084) in the voltage range from 0.1 to 3.0 V vs. Li/Li⁺ after one-cycle activation at C/20 (15 mA g⁻¹). Electrochemical impedance spectroscopy (EIS) was conducted using a Biologic VSP potentiostat.

### Results and Discussion

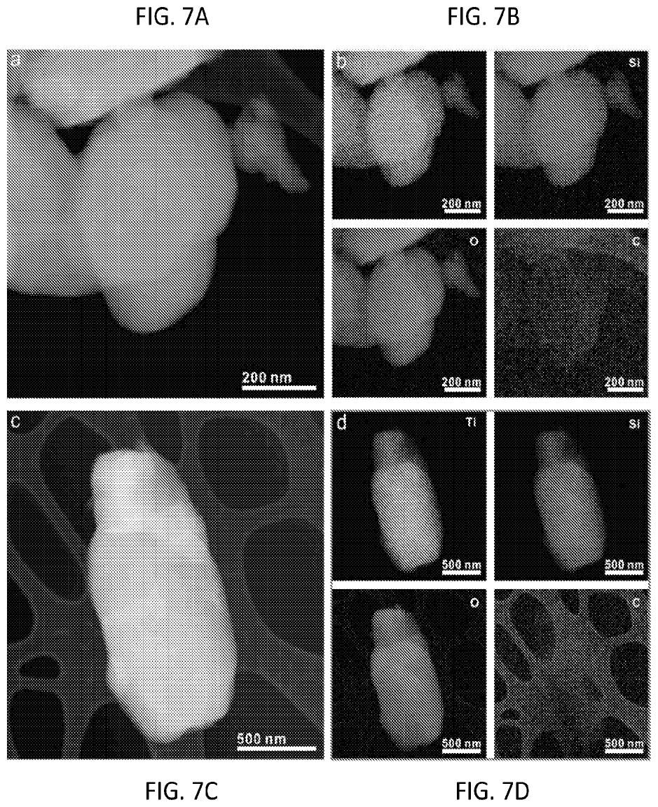

Structural Analysis: The synthesis conditions for pristine LTSO and G-LTSO are provided in the experimental procedures section above. As shown in FIG. 1A, both as-synthesized LTSO and G-LTSO have a tetragonal structure in the P4/nmm space group, which agrees well with the Joint Committee on Powder Diffraction Standards (JCPDS) database (#04-010-4344). As schematically depicted in FIG. 1B, Ti ions (cyan) form octahedra with adjacent 0 ions (red), Si ions (blue) build tetrahedra with surrounding O ions, and Li ions (green) are located between the layers composed of TiO₆ octahedra and SiO₄ tetrahedra. The LTSO nanoparticles are approximately hundreds of nanometers in size as shown in the TEM and scanning electron microscopy (SEM) images of FIGS. 1C and 6A. The high-resolution TEM (HRTEM) images shown in FIG. 1D confirm the tetragonal atomic arrangement of LTSO where the a lattice parameter is 0.648 nm, which is in close agreement with the JCPDS reference value (a=0.644 nm). FIG. 1E shows a high-angle annular dark-field scanning TEM (HAADF-STEM) image of a [001]-oriented pristine LTSO nanoparticle. Electron energy-loss spectroscopy (EELS) line profiles (FIG. 1F) and energy-dispersive X-ray spectroscopy (EDS) mapping (FIGS. 7A-7D) confirm that the LTSO nanoparticles possess a uniform composition and electronic configuration. The TEM and SEM images shown in FIGS. 1G and 6B, respectively, show that G-LTSO particles have comparable sizes to the pristine LTSO particles, and are coated and networked by graphene as indicated by the red arrows. The close-up HRTEM image in FIG. 1H shows the detailed atomic structure of G-LTSO along the [010] orientation with the graphene layers again indicated by a red arrow. The d-spacing along the [010] orientation of G-LTSO is 0.648 nm, which is the same as the d-spacing of pristine LTSO.

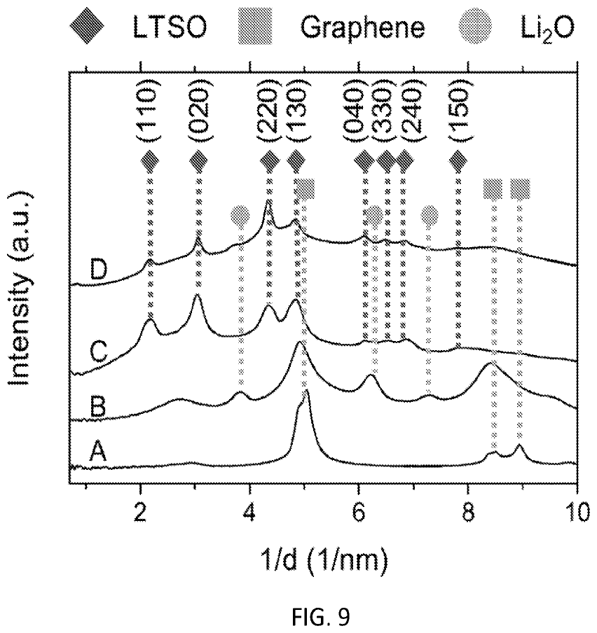

In Situ Transmission Electron Microscopy Observation: FIG. 2A sequentially shows in situ TEM images of the morphological changes in G-LTSO during lithiation. The electron beam was blanked to minimize irradiation effects except during image acquisition. After 7,200 s of lithiation, the original structure was well maintained except that the edge region started to show weak crystallinity caused by over-lithiation. To directly observe the effect of graphene encapsulation, in situ TEM observation was also performed on G-LTSO particles in a neighboring partially graphene-free region, as shown in FIGS. 8A-8G. Both the graphene-encapsulated and graphene-free regions were simultaneously connected to a lithium metal electrode, and the electron beam was blanked during in situ lithiation. As noted above, the LTSO structure is maintained in the graphene-encapsulated region (where the interlayer spacing of graphene increases due to the inserted Li ions), whereas the graphene-free region shows a perturbation to the lattice spacing of LTSO. In particular, the areal change of the G-LTSO nanoparticle was calculated during the in situ TEM measurement in FIG. 2B, which shows a minimal 4% areal expansion from 0.274 μm² to 0.285 μm². In addition, following lithiation, the G-LTSO nanoparticle shows minimal changes in atomic structure as shown in FIGS. 2C-2F. In situ selected area electron diffraction (SAED) confirms that the graphene and LTSO diffraction patterns of G-LTSO are well-maintained during the lithiation process, which is further supported by the SAED radial profiles in FIG. 9.

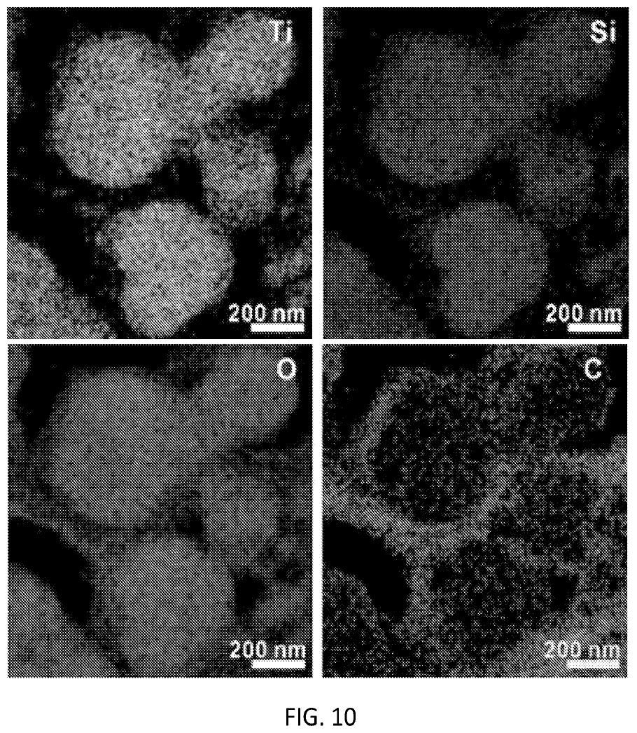

In order to investigate structural stability after cycling in fully assembled coin-cell electrodes, ex situ TEM was performed on a focused ion beam (FIB) milled electrode sample after 300 cycles at a 3C cycling rate. The LTSO particles encapsulated and networked by graphene remain intact in the G-LTSO electrode (FIG. 2G), and the corresponding EDS maps indicate uniform distributions of Ti, Si, and O in the LTSO matrix and C in the graphene coating as shown in FIG. 10. In addition, the enlarged HRTEM image in FIG. 2H indicates that the atomic structure of the LTSO matrix and the graphene coating is preserved following 300 cycles.

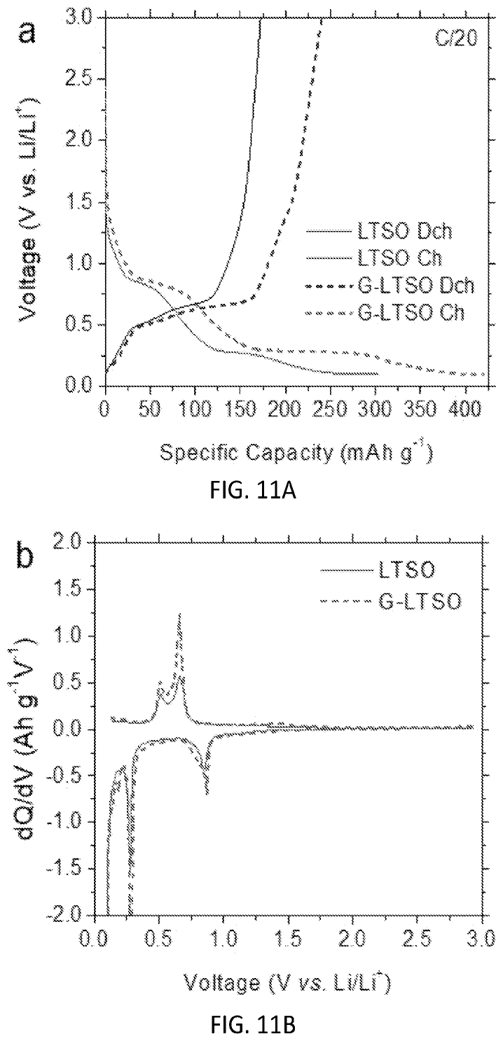

Electrochemical Characterization: The relative electrochemical performance of LTSO and G-LTSO coin-cell electrodes were evaluated by galvanostatic charge-discharge measurements at various C-rates (1C=300 mA g⁻¹) in the potential window of 0.1-3.0 V vs. Li/Li⁺. Throughout this disclosure, the charge reaction denotes the insertion of Li into the anode, and the discharge reaction indicates the extraction of Li out of the anode. To compare the low-rate behavior with and without graphene functionalization of LTSO, FIG. 11A shows comparative charge-discharge profiles at a cycling rate of C/20. The G-LTSO electrode (dashed lines) shows more well-defined reaction plateaus at about 0.8 and about 0.28 V vs. Li/Li in comparison to the pristine LTSO electrode voltage profile, although the differential capacity (dQ/dV) analysis in FIG. 11B reveals that both LTSO and G-LTSO have similar reaction potentials. In terms of lithiation capacity, G-LTSO charges to a specific capacity of 419.6 mAh g⁻¹, whereas pristine LTSO only charges to 302.4 mAh g⁻¹ during the Li insertion process. G-LTSO also shows higher discharge capacity (242.3 mAh g⁻¹) compared to pristine LTSO (173.4 mAh g⁻¹) in the Li extraction process.

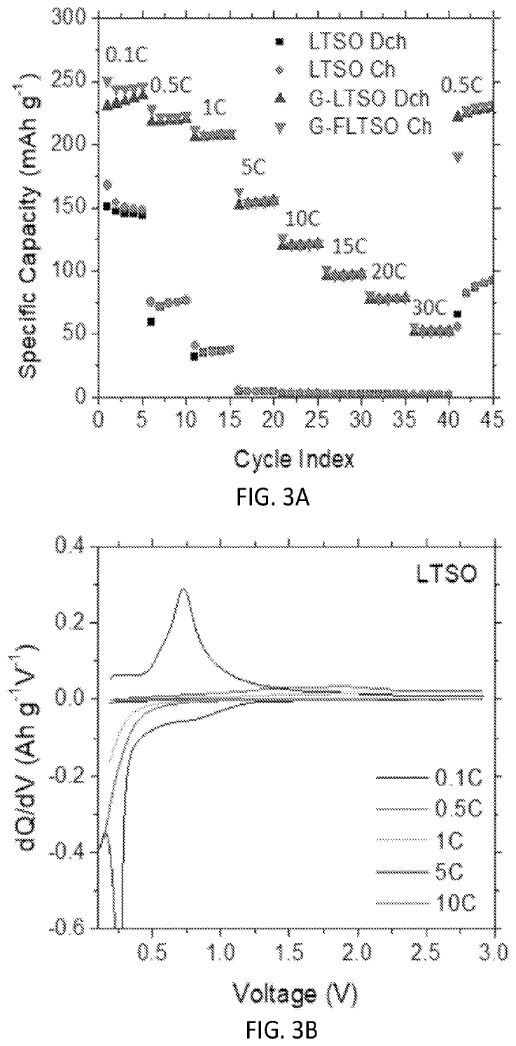

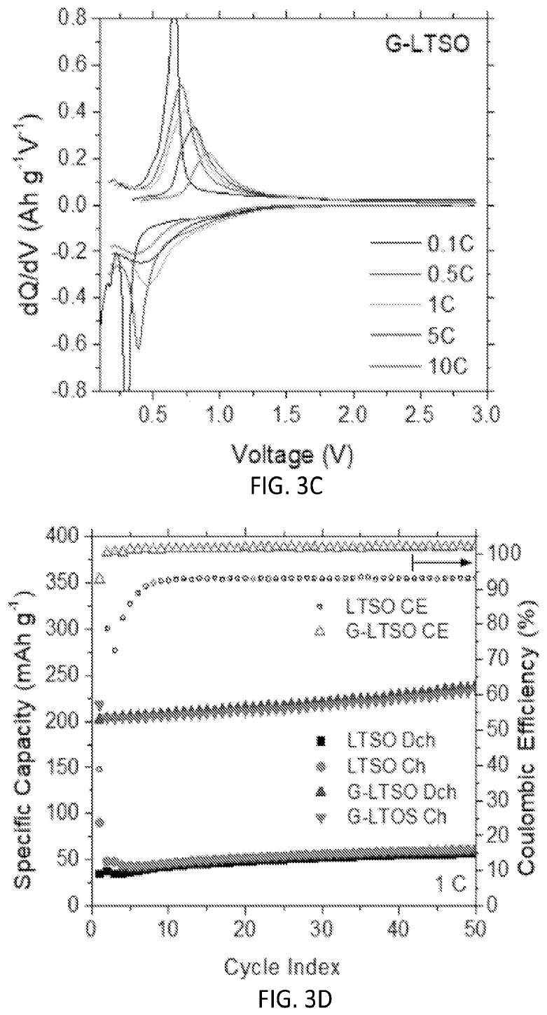

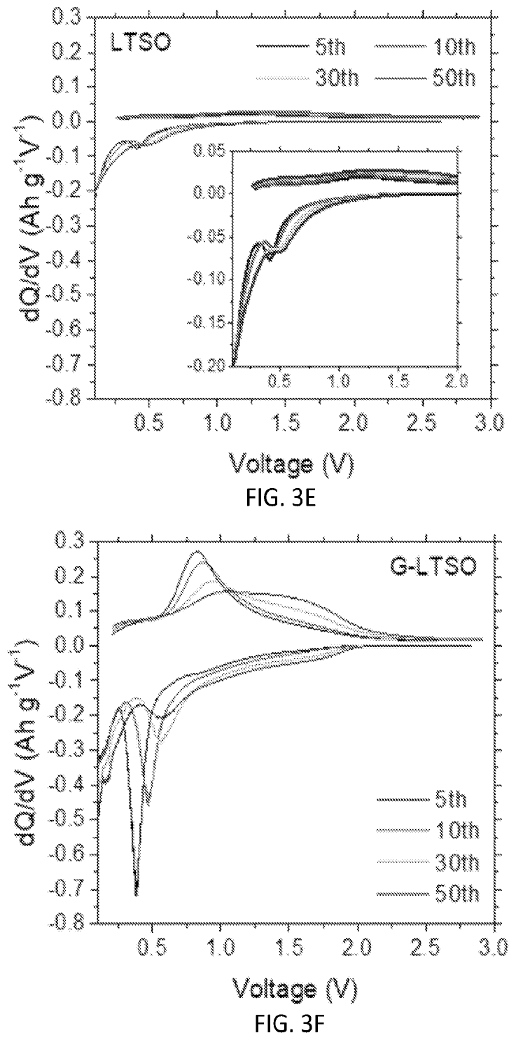

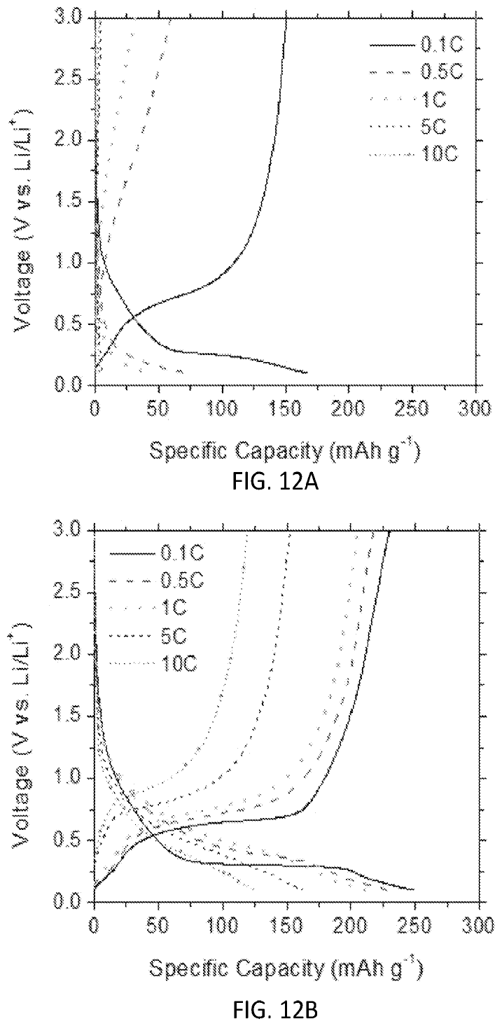

In addition to the capacity improvement at low rates, the graphene network contributes to the substantial increase of rate capability as shown in FIG. 3A. Pristine LTSO shows poor rate capability due to its intrinsically low electrical conductivity. In particular, the specific capacity of pristine LTSO dropped to about 75 mAh g⁻¹ at 0.5C and to about 35 mAh g⁻¹ at 1C as indicated in FIG. 12A, and the dQ/dV analysis in FIG. 3B reveals that distinct voltage plateaus were not observed at higher cycling rates beyond 0.1 C. On the other hand, G-LTSO shows a significantly improved high-rate performance including specific capacities exceeding 200 mAh g⁻¹ at 1 C, 150 mAh g⁻¹ at 5 C, 100 mAh g⁻¹ at 15 C, and 50 mAh g⁻¹ at 30 C, which restored back to about 225 mAh g⁻¹ at 0.5C as shown in FIGS. 3A and 12B. As evidenced by FIG. 3C, the G-LTSO dQ/dV profiles show well-defined voltage plateaus and relatively low overpotentials even at high cycling rates.

Cyclic retention tests at 1C were also performed for both LTSO and G-LTSO after an activation cycle at C/20 as depicted in FIG. 3D. As expected from the rate capability measurements, LTSO exhibits an initial specific capacity slightly below 50 mAh g⁻¹ at 1C, whereas the specific capacity of G-LTSO was initially about 200 mAh g⁻¹. Upon cycling, the specific capacity of G-LTSO gradually increased to 235 mAh g⁻¹ at the 50^{th} cycle, which indicates that the active material was gradually activated during cycling. This activation of G-LTSO partially recovers the capacity loss during the first activation cycle and results in a Coulombic efficiency slightly higher than 100%. In contrast, while LTSO also shows activation during cycling, its Coulombic efficiency is only about 93%, which implies that LTSO activates during charging but does not achieve full discharging. In other words, LTSO suffers from significant irreversibility between charging and discharging, whereas G-LTSO reversibly recovers a portion of the capacity lost in the first activation cycle. In terms of voltage fading, FIGS. 3E and 3F reveal that G-LTSO possesses significantly more stable voltage profiles compared to LTSO, whose voltage plateaus immediately disappear upon cycling.

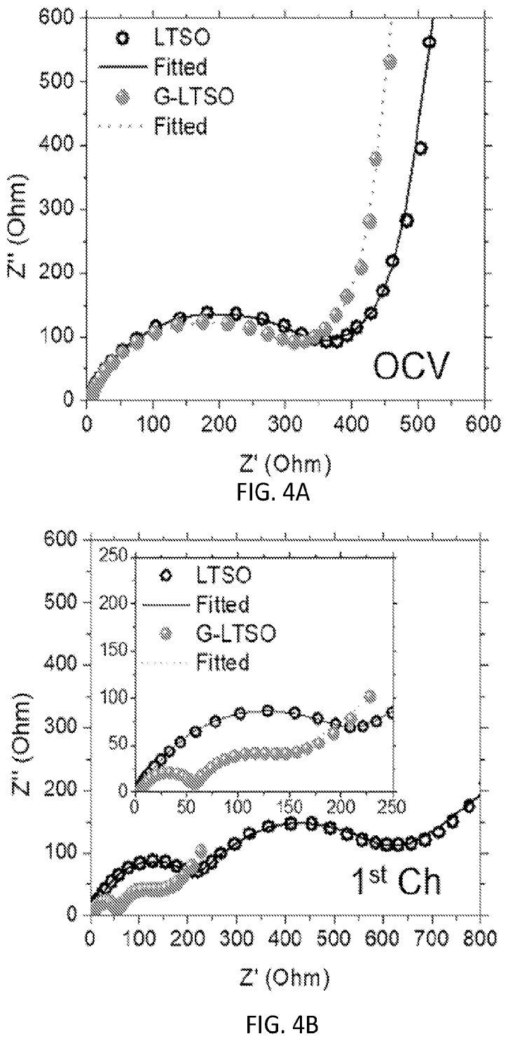

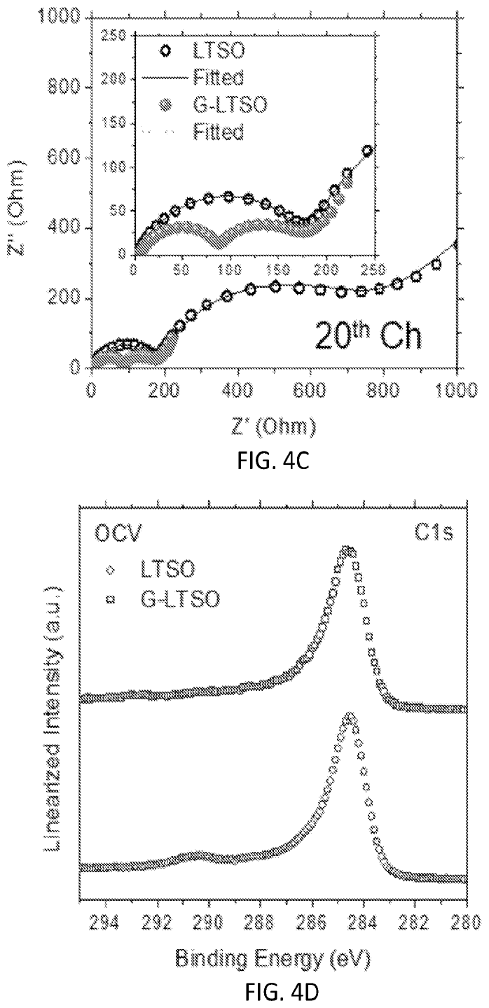

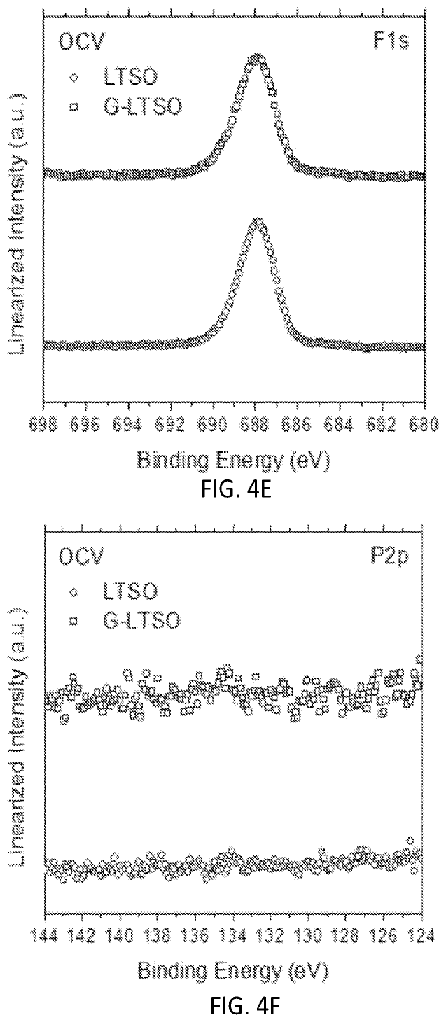

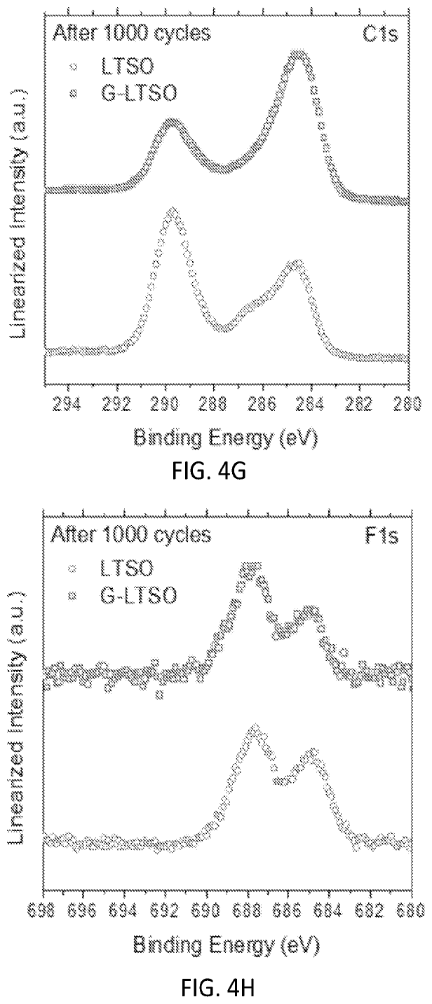

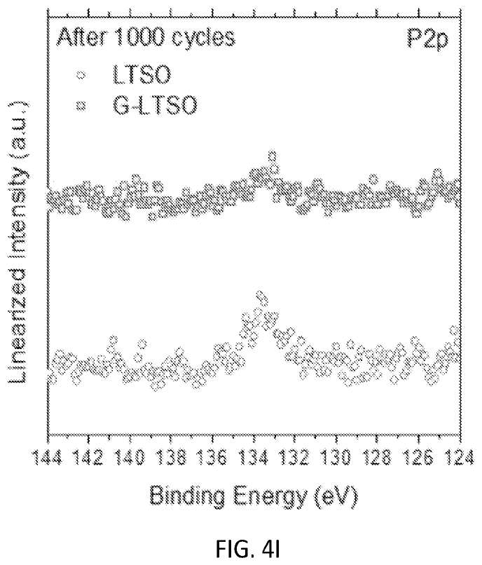

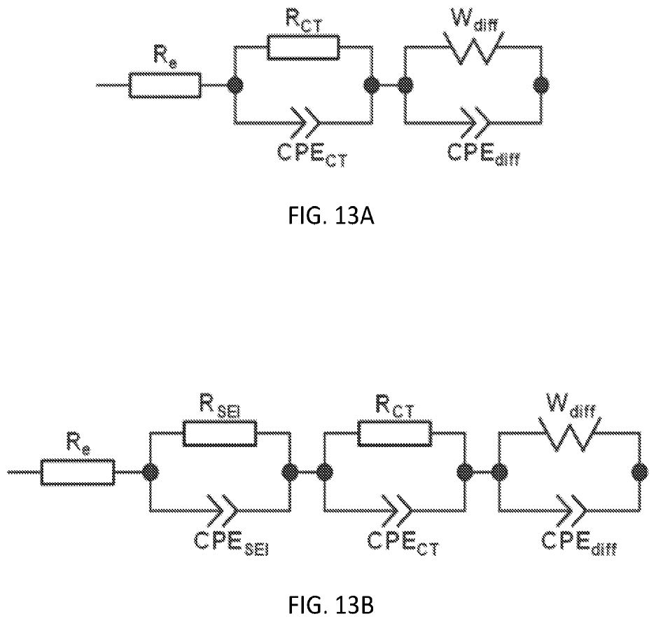

Chemical and Electrochemical Ex Situ Characterization: To further investigate the origins of the improved electrochemical performance of G-LTSO, electrochemical impedance spectroscopy (EIS) analysis was performed before and after cycling. FIG. 4A shows the impedance spectra at the open-circuit voltage (OCV) condition, where the fit is performed using the equivalent circuit model (ECM) depicted in FIG. 13A. FIGS. 4B-4C show the impedance spectra after the 1^{st} charge and 20^{th} charge, respectively, with the curves fit by the ECM depicted in FIG. 13B. Rₑ denotes a high-frequency Ohmic resistance attributed to the electrolyte, R_{CT} represents the interfacial charge-transfer resistance, and W_{diff} represents Li-ion diffusion into the LTSO particles at lower frequencies. The constant phase elements (CPEs) describe the corresponding capacitances. Additional circuit elements are included for the impedance spectra in FIGS. 4B-4C to model the resistance R_{SEI} and capacitance CPE_{SEI} resulting from the formation of the solid-electrolyte interphase (SEI) upon cycling. The values of the resistances are displayed in Table 1. Rₑ for all cases show similar values in the range of 3.7-4.9Ω, which is expected since the same electrolyte and cell configuration were used for all coin-cell measurements. At the OCV condition, both LTSO and G-LTSO impedance spectra show one semicircle that describes the charge-transfer resistance (R_{CT}), followed by the Warburg impedance (W_{diff}) at lower frequencies. Not only is the R_{CT} of G-LTSO (425.1Ω) initially lower than that of LTSO (469.5Ω) at the OCV condition but also the difference in R_{CT} between G-LTSO and LTSO increases during cycling. Additionally, the R_{SEI} of LTSO after cycling is approximately a factor of 4 higher than G-LTSO. These extracted resistances confirm that graphene provides more efficient charge transport pathways in addition to minimizing the SEI layer for G-LTSO compared to pristine LTSO.

TABLE 1
Electrochemical impedance spectroscopy fitting
parameters of LTSO and G-LTSO at the OCV condition, after
1^{st} charge, and after 20^{th} charge.

| | | Rₑ [Ω] | R_{SEI} [Ω] | R_{CT} [Ω] |
|---|---|---|---|---|
| LTSO | OCV | 4.0 | — | 469.5 |
| | 1^{st} charge | 3.8 | 201.5 | 377.2 |
| | 20^{th} charge | 3.9 | 175.6 | 588.8 |
| G-LTSO | OCV | 4.9 | — | 425.1 |
| | 1^{st} charge | 3.7 | 51.5 | 70.5 |
| | 20^{th} charge | 4.0 | 78.3 | 90.9 |

To probe chemical changes, LTSO and G-LTSO electrodes were characterized with X-ray photoelectron spectroscopy (XPS) following 1,000 charge/discharge cycles. Specifically, XPS spectra for C1s, F1s, and P2p before and after cycling provide insight into the formation of the SEI. FIGS. 4D and 4G show the C1s spectra at the OCV condition and after cycling, respectively. The major peaks in the C1s spectra are at about 284.6 eV and about 289.8 eV, which are assigned to graphitic C—C bonds and carbonate bonds, respectively, where the carbonate bonds can be attributed to Li₂CO₃ compounds formed in the SEI. As expected, FIG. 4D shows that the carbonate peak is negligible before cycling for both LTSO and G-LTSO. However, after cycling, the carbonate peak is present in both materials but with a significantly higher intensity for LTSO in comparison to G-LTSO, which is consistent with suppressed SEI formation for G-LTSO as has been observed for other graphene-coated LIB electrodes. For the F1s spectra, a prominent peak is evident at about 687.5 eV for LTSO and G-LTSO both before (FIG. 4E) and after (FIG. 4H) cycling due to the polyvinylidene fluoride (PVDF) that is used as the binder in all cases. However, after cycling (FIG. 4H), the peak at about 684.5 eV is attributed to LiF in the SEI, which is again more pronounced for LTSO compared to G-LTSO. For the P2p spectra, the initial condition preceding cycling (FIG. 4F) shows virtually no signal since the LiPF₆ salt was thoroughly rinsed from the electrodes using dimethyl carbonate. In contrast, after cycling (FIG. 4I), P—O compounds from the SEI layer are evident at about 133.5 eV, with a higher signal for LTSO compared to G-LTSO, which further corroborates SEI suppression by graphene in G-LTSO.

Benchmarking Battery Performance Metrics: As discussed above, graphene functionalization imparts several attributes to LTSO electrodes including suppressed surface phase transformation and reduced SEI formation during electrochemical cycling. In addition, graphene imparts improved charge transport characteristics that minimize electrode impedance. As noted in the experimental procedures, the conformal graphene encapsulation is enabled by the ethyl cellulose polymer that stabilizes the initial graphene/LTSO dispersion. The ethyl cellulose based processing also promotes significant compaction of the electrode, resulting in an exceptional 80% electrode packing density (2.122 g cm⁻³) compared to the theoretical electrode density (2.578 g cm⁻³), which exceeds the electrode packing density of other reported state-of-the-art anode electrodes (e.g., Nb₁₆W₅O₅₅, Nb₂O₅/G, T-Nb₂O₅, LTO/C, T/LTO, and graphite) as shown in FIG. 5A and Table 2. When this high electrode density is combined with the aforementioned low operating voltage, G-LTSO enables exceptional volumetric energy density in comparison to other non-alloying anode materials. Additionally, the high-rate performance for G-LTSO implies that this record non-alloying anode volumetric energy density extends over a wide specific current range between 10¹ and 10⁴ mA g⁻¹, as shown in FIG. 5B and Table 3. Overall, these superlative battery performance metrics position G-LTSO as a leading candidate anode material for next-generation LIB technologies.

TABLE 2
Calculation of electrode density. As a function of electrode mass and
volume, electrode density was calculated by considering all of
the components in the electrode such as the active material,
conductive carbon, and binder following the reports.
$Electrode Density [ g {cm}^{- 3} ] = \frac{Elec trode Mass [ g ]}{E l e c trode Volume [ {cm}^{3} ]}$

| | Electrode density | Theoretical | Electrode packing |
|---|---|---|---|
| Material | (g cm⁻³) | density (g cm⁻³) | percentage (%) |
| G-LTSO | 2.12 | 2.58 | 82.3 |
| Nb₁₆W₅O₅₅ [1] | 2.28 | 4.34 | 52.6 |
| Nb₂O₅/G [2] | 1.54 | 3.85 | 40.0 |
| T-Nb₂O₅ [3] | 1.40 | 4.38 | 31.9 |
| LTO/C [4] | 1.15 | 2.90 | 39.7 |
| T/LTO [5] | 1.45 | 3.14 | 46.2 |
| Graphite [6] | 0.50 | 2.00 | 25.0 |

TABLE 3
Calculation of volumetric energy density. By using the
estimated electrode density in Table 2, the volumetric
energy density was calculated by multiplying the gravimetric
energy density and electrode density.

| | Specific current | Volumetric energy |
|---|---|---|
| Material | (mA g⁻¹) | density (Wh l⁻¹) |
| G-LTSO | 150.0 | 1424.7 |
| Nb₁₆W₅O₅₅ [1] | 171.3 | 1022.8 |
| Nb₂O₅/G [2] | 200.0 | 629.4 |
| T-Nb₂O₅ [3] | 200.0 | 474.4 |
| LTO/C [4] | 175.0 | 485.9 |
| T/LTO [5] | 170.0 | 549.2 |
| Graphite [6] | 186.0 | 546.0 |

### CONCLUSIONS

In the exemplary study, a high-performance LTSO anode is developed through conformal graphene encapsulation. The graphene coating provides a high conductivity network in addition to suppressed SEI formation as confirmed by TEM and XPS, which minimizes impedance and results in improved electrochemical performance at high rates. In situ TEM further shows that G-LTSO undergoes reduced structural reorganization during electrochemical cycling, which underlies enhanced cycle lifetimes and reduced overpotentials. The ethyl cellulose polymer that is instrumental to the conformal graphene coating also enhances compaction of the electrode, which, in concert with the low operating voltage of G-LTSO, results in record-setting volumetric energy densities over a wide specific current range. The exceptional volumetric energy and power densities demonstrated here are likely to have broad impact on a diverse range of emerging LIB applications such as electric vehicles and grid-level energy storage.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Tarascon, J. M. and Armand, M. (2001). Issues and challenges facing rechargeable lithium batteries. Nature 414, 359-367.
[2]. 2. Goodenough, J. B. and Park, K. S. (2013). The Li-ion rechargeable battery: A perspective. J. Am. Chem. Soc. 135, 1167-1176.
[3]. 3. Lu, L. G., Han, X. B., Li, J. Q., Hua, J. F., and Ouyang, M. G. (2013). A review on the key issues for lithium-ion battery management in electric vehicles. J. Power Sources 226, 272-288.
[4]. 4. Son, I. H., Park, J. H., Park, S., Park, K., Han, S., Shin, J., Doo, S. G., Hwang, Y., Chang, H., and Choi, J. W. (2017). Graphene balls for lithium rechargeable batteries with fast charging and high volumetric energy densities. Nat. Commun. 8, 1561.
[5]. 5. Dahn, J. R., Zheng, T., Liu, Y. H., and Xue, J. S. (1995). Mechanisms for lithium insertion in carbonaceous materials. Science 270, 590-593.
[6]. 6. Ming, J., Cao, Z., Wahyudi, W., Li, M. L., Kumar, P., Wu, Y. Q., Hwang, J. Y., Hedhili, M. N., Cavallo, L., Sun, Y. K., et al. (2018). New insights on graphite anode stability in rechargeable batteries: Li ion coordination structures prevail over solid electrolyte interphases. ACS Energy Lett. 3, 335-340.
[7]. 7. Scrosati, B. and Garche, J. (2010). Lithium batteries: Status, prospects and future. J. Power Sources 195, 2419-2430.
[8]. 8. Goriparti, S., Miele, E., De Angelis, F., Di Fabrizio, E., Zaccaria, R. P., and Capiglia, C. (2014). Review on recent progress of nanostructured anode materials for Li-ion batteries. J. Power Sources 257, 421-443.
[9]. 9. Nitta, N., Wu, F. X., Lee, J. T., and Yushin, G. (2015). Li-ion battery materials: Present and future. Mater. Today 18, 252-264.
[10]. 10. Li, W. Y., Yao, H. B., Yan, K., Zheng, G. Y., Liang, Z., Chiang, Y. M., and Cui, Y. (2015) The synergetic effect of lithium polysulfide and lithium nitrate to prevent lithium dendrite growth. Nat. Commun. 6, 7436.
[11]. 11. Boukamp, B. A., Lesh, G. C., and Huggins, R. A. (1981). All-solid lithium electrodes with mixed-conductor matrix. J. Electrochem. Soc. 128, 725-729.
[12]. 12. Chan, C. K., Peng, H. L., Liu, G., Mcllwrath, K., Zhang, X. F., Huggins, R. A., and Cui, Y. (2008). High-performance lithium battery anodes using silicon nanowires. Nat. Nanotechnol. 3, 31-35.
[13]. 13. Zaghib, K., Simoneau, M., Armand, M., and Gauthier, M. (1999). Electrochemical study of Li₄Ti₅O₁₂ as negative electrode for Li-ion polymer rechargeable batteries. J. Power Sources 81, 300-305.
[14]. 14. Aldon, L., Kubiak, P., Womes, M., Jumas, J. C., Olivier-Fourcade, J., Tirado, J. L., Corredor, J I., and Vicente, C. P. (2004). Chemical and electrochemical Li-insertion into the Li₄Ti₅O₁₂ spinel. Chem. Mater. 16, 5721-5725.
[15]. 15. Yi, T. F., Jiang, L. J., Shu, J., Yue, C. B., Zhu, R. S., and Qiao, H. B. (2010). Recent development and application of Li₄Ti₅O₁₂ as anode material of lithium ion battery. J. Phys. Chem. Solids 71, 1236-1242.
[16]. 16. Griffith, K. J., Forse, A. C., Griffin, J. M., and Grey, C. P. (2016). High-rate intercalation without nanostructuring in metastable Nb₂O₅ bronze phases. J. Am. Chem. Soc. 138, 8888-8899.
[17]. 17. Griffith, K. J., Wiaderek, K. M., Cibin, G., Marbella, L. E., and Grey, C. P. (2018). Niobium tungsten oxides for high-rate lithium-ion energy storage. Nature 559, 556-563.
[18]. 18. Sun, H. T., Mei, L., Liang, J. F., Zhao, Z. P., Lee, C., Fei, H. L., Ding, M. N., Lau, J., Li, M. F., Wang, C., et al. (2017). Three-dimensional holey-graphene/niobia composite architectures for ultrahigh-rate energy storage. Science 356, 599-604.
[19]. 19. Liu, J. Y., Pang, W. K., Zhou, T., Chen, L., Wang, Y. G., Peterson, V. K., Yang, Z. Q., Guo, Z. P., and Xia, Y. Y. (2017). Li₂TiSiO₅: A low potential and large capacity Ti-based anode material for Li-ion batteries. Energ. Environ. Sci. 10, 1456-1464.
[20]. 20. Liu, J. Y., Liu, Y., Hou, M. Y., Wang, Y. G., Wang, C. X., and Xia, Y. Y. (2018). Li₂TiSiO₅ and expanded graphite nanocomposite anode material with improved rate performance for lithium-ion batteries. Electrochim. Acta 260, 695-702.
[21]. 21. Wang, S. J., Wang, R. T., Bian, Y., Jin, D. D., Zhang, Y. B., and Zhang, L. (2019). In-situ encapsulation of pseudocapacitive Li₂TiSiO₅ nanoparticles into fibrous carbon framework for ultrafast and stable lithium storage. Nano Energy 55, 173-181.
[22]. 22. Liu, N., Lu, Z. D., Zhao, J., McDowell, M. T., Lee, H. W., Zhao, W. T., and Cui, Y. (2014). A pomegranate-inspired nanoscale design for large-volume-change lithium battery anodes. Nat. Nanotechnol. 9, 187-192.
[23]. 23. Chen, K. S., Xu, R., Luu, N. S., Secor, E. B., Hamamoto, K., Li, Q. Q., Kim, S., Sangwan, V. K., Balla, I., Guiney, L. M., et al. (2017). Comprehensive enhancement of nanostructured lithium-ion battery cathode materials via conformal graphene dispersion. Nano Lett. 17, 2539-2546.
[24]. 24. Jaber-Ansari, L., Puntambekar, K. P., Kim, S., Aykol, M., Luo, L. L., Wu, J. S., Myers, B. D., Iddir, H., Russell, J. T., Saldana, S. J., et al. (2015). Suppressing manganese dissolution from lithium manganese oxide spinel cathodes with single-layer graphene. Adv. Energy Mater. 5, 1500646.
[25]. 25. Wang, C., Wang, S. A., He, Y. B., Tang, L. K., Han, C. P., Yang, C., Wagemaker, M., Li, B. H., Yang, Q. H., Kim, J. K., et al. (2015). Combining fast Li-ion battery cycling with large volumetric energy density: Grain boundary induced high electronic and ionic conductivity in Li₄Ti₅O₁₂ spheres of densely packed nanocrystallites. Chem. Mater. 27, 5647-5656.
[26]. 26. Singh, D. P., Mulder, F. M., and Wagemaker, M. (2013). Templated spinel Li₄Ti₅O₁₂ Li-ion battery electrodes combining high rates with high energy density. Electrochem. Commun. 35, 124-127.
[27]. 27. Billaud, J., Bouville, F., Magrini, T., Villevieille, C., and Studart, A. R. (2016). Magnetically aligned graphite electrodes for high-rate performance Li-ion batteries. Nat. Energy 1, 16097.
[28]. 28. Secor, E. B., Prabhumirashi, P. L., Puntambekar, K., Geier, M. L., and Hersam, M. C. (2013). Inkjet printing of high conductivity, flexible graphene patterns. J. Phys. Chem. Lett. 4, 1347-1351.

What is claimed is:

1. A composite, comprising:
graphene; and
nanoparticles of an anode active material for an electrochemical device, wherein said nanoparticles are conformally coated and networked by said graphene.

2. The composite of claim 1, wherein individual said nanoparticles, rather than multi-particle particulates, are conformally coated with said graphene.

3. The composite of claim 1, wherein each of said nanoparticles is uniformly and conformally coated with said graphene.

4. The composite of claim 1, wherein each of said nanoparticles is coated with amorphous carbon with sp²-carbon content along with said graphene.

5. The composite of claim 1, wherein a weight ratio of said graphene to said nanoparticles of the anode active material is in a range from about 1:1000 to about 1:10.

6. The composite of claim 1, wherein said graphene comprises solution-exfoliated graphene.

7. The composite of claim 1, further comprising amorphous carbon with sp²-carbon content.

8. The composite of claim 7, wherein the amorphous carbon is an annealation product of ethyl cellulose.

9. The composite of claim 8, being formed by annealing a mixture of said nanoparticles, said graphene, and ethyl cellulose at a temperature for a period of time to decompose the ethyl cellulose, thereby resulting in said composite having said annealation product of the ethyl cellulose.

10. The composite of claim 1, wherein the atomic structure of said composite is well-maintained during or/and after lithiation.

11. The composite of claim 1, wherein said anode active material comprises Li₂TiSiO₅ (LTSO), lithium titanium oxides, niobium oxides, titanium niobium oxides, or a combination thereof.

12. The composite of claim 11, wherein the d-spacing along the [010] orientation of said composite is 0.648 nm.

13. An anode electrode for an electrochemical device, comprising:
a composite comprising graphene, and nanoparticles of an active material, wherein said nanoparticles are conformally coated and networked by said graphene.

14. The anode electrode of claim 13, wherein individual said nanoparticles, rather than multi-particle particulates, are conformally coated with said graphene.

15. The anode electrode of claim 13, wherein each of said nanoparticles is uniformly and conformally coated with said graphene.

16. The anode electrode of claim 13, wherein each of said nanoparticles is coated with amorphous carbon with sp²-carbon content along with said graphene.

17. The anode electrode of claim 13, wherein a weight ratio of said graphene to said nanoparticles of the active material is in a range from about 1:1000 to about 1:10.

18. The anode electrode of claim 13, wherein said graphene comprises solution-exfoliated graphene.

19. The anode electrode of claim 13, wherein said composite further comprises amorphous carbon with sp²-carbon content.

20. The anode electrode of claim 19, wherein the amorphous carbon is an annealation product of ethyl cellulose.

21. The anode electrode of claim 20, wherein said composite is formed by annealing a mixture of said nanoparticles, said graphene, and ethyl cellulose at a temperature for a period of time to decompose the ethyl cellulose, thereby resulting in said composite having said annealation product of the ethyl cellulose.

22. The anode electrode of claim 13, wherein the atomic structure of said composite is well maintained during or/and after lithiation.

23. The anode electrode of claim 13, wherein said active material comprises Li₂TiSiO₅ (LTSO), lithium titanium oxides, niobium oxides, titanium niobium oxides, or a combination thereof.

24. The anode electrode of claim 23, wherein the d-spacing along the [010] orientation of said composite is 0.648 nm.

25. The anode electrode of claim 23, wherein the atomic structure of the LTSO matrix and the graphene coating in the anode electrode remains intact following 300 cycles.

26. The anode electrode of claim 13, wherein in operation, said composite reversibly recovers a portion of the capacity lost in the first activation cycle.

27. The anode electrode of claim 13, wherein said anode electrode has suppressed surface phase transformation and reduced solid-electrolyte interphase (SEI) formation during electrochemical cycling.

28. The anode electrode of claim 13, wherein said electrode has an electrode packing density higher than 1.0 g cm⁻³, and an operating voltage lower than 1.5 V.

29. The anode electrode of claim 28, wherein said electrode packing density is equal to or greater than 50% of the theoretical electrode packing density.

30. The anode electrode of claim 13, wherein said electrode has a volumetric energy density greater than that of an electrode formed of a non-alloying anode material.

31. The anode electrode of claim 30, wherein the volumetric energy density extends over a wide specific current range between 10¹ and 10⁴ mA g⁻¹.

32. A method for forming a composite, comprising:
agitating a mixture of nanoparticles of an anode active material, graphene, and ethyl cellulose in a solvent to disperse said nanoparticles and said graphene with the ethyl cellulose so as to prevent aggregation of said nanoparticles; and
annealing the agitated mixture at a temperature for a period of time to decompose the ethyl cellulose, thereby resulting in said composite,
wherein said nanoparticles are conformally coated and networked by said graphene.

33. The method of claim 32, wherein individual said nanoparticles, rather than multi-particle particulates, are conformally coated with said graphene.

34. The method of claim 32, wherein each of said nanoparticles is uniformly and conformally coated with said graphene.

35. The method of claim 32, wherein each of said nanoparticles is coated with amorphous carbon with sp²-carbon content along with said graphene.

36. The method of claim 32, wherein a weight ratio of said graphene to said nanoparticles of the anode active material is in a range from about 1:1000 to about 1:10.

37. The method of claim 32, wherein said graphene comprises solution-exfoliated graphene.

38. The method of claim 32, wherein said composite further comprises amorphous carbon with sp²-carbon content.

39. The method of claim 38, wherein the amorphous carbon is an annealation product of ethyl cellulose.

40. The composite of claim 32, wherein the atomic structure of said composite is well-maintained during or/and after lithiation.

41. The method of claim 1, wherein said anode active material comprises Li₂TiSiO₅ (LTSO), lithium titanium oxides, niobium oxides, titanium niobium oxides, or a combination thereof.
